(19) United States
(12) Patent Application Publication
(10) Pub. No.: US 2003/0115167 A1
(43) Pub. Date: Jun. 19, 2003

(54) Web browser implemented in an Internet appliance

(76) Inventors: IMRAN Sharif, MILPITAS, CA (US); JOHN BREMSTELLER, CARROLLTON, TX (US); GLEN EDWARD IVEY, FT BRAGG, CA (US); WILLIAM KNAPP, SAN JOSE, CA (US)

Correspondence Address: ROBERT BUCKLEY, PATENT ATTORNEY, 462 N M ST., LIVERMORE, CA, 94551-2828, US

(21) Appl. No.: 09/902,986

(22) Filed: Jul. 11, 2001

Related U.S. Application Data
(60) Provisional application No. 60/217,628, filed on Jul. 11, 2000.

(51) Int. Cl. G06F 7/00

(52) U.S. Cl. 707/1

(57) ABSTRACT

A web browser application implemented in an Internet appliance for accessing information on the Internet. The Internet appliance has a display device and using a reduced-keyset user interface device having only direction keys, numeric keys, and a number of function keys for user input. The browser displays a user interface screen divided into a primary screen area for displaying information and one or more control areas containing mode icons and command icons. In a navigate mode, the browser displays a plurality of interface elements in the primary screen area, each interface element representing a web page. The user accesses one of the web pages through the use of the keys. In a browse mode, the browser displays page contents of a web page in the primary screen area, the web page including one or more interface elements. The user browses through the web pages through the use of the reduced-keyset user interface device. To provide easy navigation and browsing, the browser dynamically associates mode/command icons and/or interface elements such as links with individual keys of the reduced-keyset user interface device and displays the association on the screen, so that the user may invoke an icon or a link by pressing a single key.

### CLAIM FOR PRIORITY

Priority is hereby claimed from Provisional Patent Application Serial No. 60/217,628, filed Jul. 11, 2000, for “WEB Browser Implemented in an Internet Appliance Using a Remote Control Unit for User Input”.

### FIELD OF THE INVENTION

This invention relates to a web browser implemented in an Internet appliance using a reduced-keyset user interface device for user input, and in particular, to a graphical user interface for such a web browser.

### BACKGROUND OF THE INVENTION

The most prevalent, and virtually the only practical way for a user to access the Internet today is through a personal computer (PC). Other means to access the Internet are available, such as WebTV (Microsoft) and lopener (Netpliance), but these devices are essentially “low end versions” of a PC. Many PC users do not take advantage of all the benefits of a PC, including many of its Internet capabilities. For example, a PC is capable of sending and receiving music and audio clips and video clips via the Internet with relative ease for a full time PC user. Many PC users, however, do not use these capabilities. The reasons not to use these capabilities include the amount of training required to fully utilize the full capabilities of a PC, the unreliability of performance of a PC with respect to such functions, etc. On the other hand, a user that fully utilizes the Internet-access and multimedia capabilities of a PC may not need its other functions such as word processing, spread sheets, etc. Further, PCs have high cost of ownership in that they are hard to learn, configure, and maintain.

### SUMMARY OF THE INVENTION

Accordingly, there is a need for low-cost and easy-to-use devices for accessing the Internet. The present invention is directed to non-PC devices useful for accessing the Internet that meet such a need.

An object of the present invention is to provide a web browser implemented in non-PC Internet access devices, or “Internet appliances,” that are reliable and require low manufacturing and maintenance cost and minimum training for the users, as well as easy and convenient to use.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the present invention provides a web browser application implemented in an Internet appliance that allows a user to browse the Internet solely through the user of a reduced-keyset user interface device.

In another aspect, the present invention provides a user interface method in a browser application implemented in an Internet appliance for accessing information on the Internet, the Internet appliance having a display device and using a reduced-keyset user interface device. The method includes displaying a user interface screen on the display device, the screen being divided into a primary screen area for displaying information and at least a first and a second control area, the first control area containing one or more mode icons for selecting a mode, the second control area containing one or more command icons depending on the selected mode. In a navigate mode, the user interface displays a plurality of interface elements in the primary screen area, each interface element representing a web page, and accesses one of the web pages by invoking a command icon or an interface element in response to user input through the use of the reduced-keyset user interface device. In a browse mode, the user interface displays page contents of a web page in the primary screen area, the web page including one or more interface elements, and further displays different page contents by invoking a command icon or an interface element in response to user input through the use of the reduced-keyset user interface device. In the navigate and/or browse mode, the user interface dynamically displays indications that associate each of one or more command icons and/or interface elements with a key on the reduced-keyset user interface device, and invokes a command icon and/or interface element in response to user input through the use of the associated key.

It is to be understood that both the foregoing general description and the following detailed description are exemplary and explanatory and are intended to provide further explanation of the invention as claimed.

### BRIEF DESCRIPTION OF THE DRAWINGS

FIG. 1(a) illustrates a display screen of a web browser according to an embodiment of the present invention.

FIG. 1(b) illustrates another display screen of the web browser where advertising material is displayed.

FIG. 2 shows a sample working icon animation for the browser display screen.

FIG. 3 illustrates a browser display screen displaying an association of user interface elements and numeric keys of the reduced-keyset user interface device.

FIG. 4 shows a sample display screen of the browser in the Navigation mode.

FIG. 5 shows a sample display screen in the Browse mode.

FIG. 6 shows a sample Browse mode Zoom screen display with scroll bars.

FIG. 7 shows a sample display screen in the Navigation mode with scrollable display.

FIG. 8 shows a sample display screen in the Navigation mode when the RECENT command is invoked.

FIG. 9 shows a sample display screen in the Navigation mode when the MARKED command is invoked.

FIG. 10 shows a sample display screen in the Navigation mode when the RECOMMENDED command is invoked.

FIG. 11 is an example of text element selections for interface device key assignment in the Browse mode.

FIG. 12 illustrates a method of assigning interface device keys to screen elements in a Browsing Screen.

FIG. 13(a) shows a division of Browsing Screen areas into quadrants for navigation.

FIG. 13(b) shows an example of direction key mapping computation.

FIG. 14 illustrates a display screen depicting numeric keys assigned to page elements.

FIG. 15 illustrates a Back Menu command dialog box.

FIG. 16 illustrates a Browsing Screen where the input focus is on the scroll bars.

FIG. 17 illustrates a Browse Screen with frames.

FIG. 18 illustrates a Browse mode Zoom screen display in the Full-Screen configuration.

FIG. 19 illustrates a Browse mode Zoom screen display in the Windowed configuration.

FIG. 20 illustrates a display screen in the Help mode.

FIG. 21 schematically illustrates an Internet appliance in which the web browser may be implemented.

FIG. 22 illustrates a network connection configuration for an Internet appliance.

FIG. 23 shows the keypad layout of a reduced-keyset user interface device useful as a user interface device for an Internet appliance.

### DESCRIPTION OF DESCRIPTION OF THE PREFERRED EMBODIMENTS

FIG. 21 shows an Internet appliance in which a web browser according to embodiments of the present invention may be implemented. An Internet appliance 201 is a small device that includes a processing unit 210; a wired or wireless network connection device 212 such as a modem for communication with a network; a video section 214 including a video signal output, such as a television interface for outputting video and audio signals, or separate video and audio signal outputs; and a user interface signal receiver 216 for receiving user interface signals generated by a reduced-keyset user interface device 202, such as a consumer-type remote control unit. The above components are preferably contained in a housing 211 or provided on the outside surface of the housing to form an integral unit. The processing unit is connected to the network connection device 212, the video section 214 and the user interface signal receiver 216 and controls all functions of the Internet appliance. The reduced-keyset user interface device is a device that has a small number of keys and transmits a small number of keystroke signals associated with the keys. As used in this specification, the term “reduced-keyset user interface device” does not include a device that has a full text-entry keyboard. The video section 214 can be connected to a display such as a television for displaying information, and the Internet appliance unit does not have its own video display or other graphic display devices. The user interface signal receiver 216 is the only device for receiving user interface information from the user (via the reduced-keyset user interface device 202), and the Internet appliance unit does not have its own keyboard input device with text-entry keys. The lack of an integral video display device and a keyboard allows the Internet appliance to have a compact structure. User interface is provided solely through the cooperation with video display and the reduced-keyset user interface device 202.

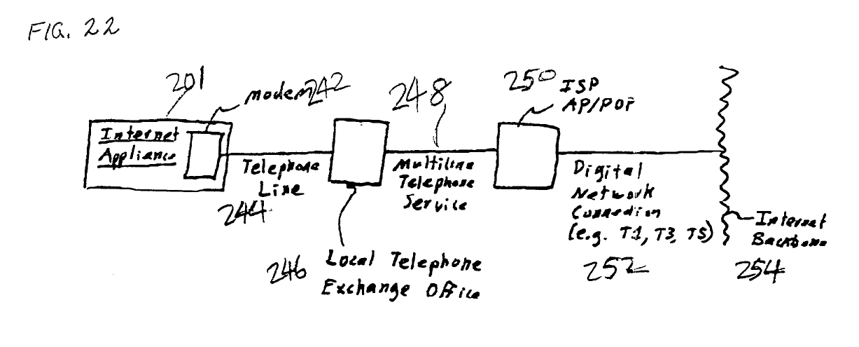

An Internet appliance is preferably connected to a network to perform its function. A typical network connection is to the Internet, but other types of network may also be used, such as an intranet. The term “Internet appliance” is intended to cover devices connected to other types of networks. For internet appliances that connect to the network using a modem, an Internet Service Provider (ISP) is typically employed to provide the hardware and software infrastructure that provides the link between the modem in the appliance and the other systems on the network to which it connects. FIG. 22 illustrates an Internet appliance connection topology using a modem 242. In the illustrated embodiment, the Internet appliance 201 is connected to a local telephone exchange office 246 via a telephone line 244. An ISP AP/POP 250 is connected to the local telephone exchange office 246 via a multiline telephone service 248 and to the Internet backbone 254 via a digital network connection 252 such as T1, T3 or T5 lines. An Internet appliance network connection shown in FIG. 22 using a telephone modem is suitable for appliances that interoperate with fax systems, but the category of Internet appliance devices are not limited to those employing a modem for their network connection. Any network connection technology, wired or wireless, may be employed by an Internet appliance.

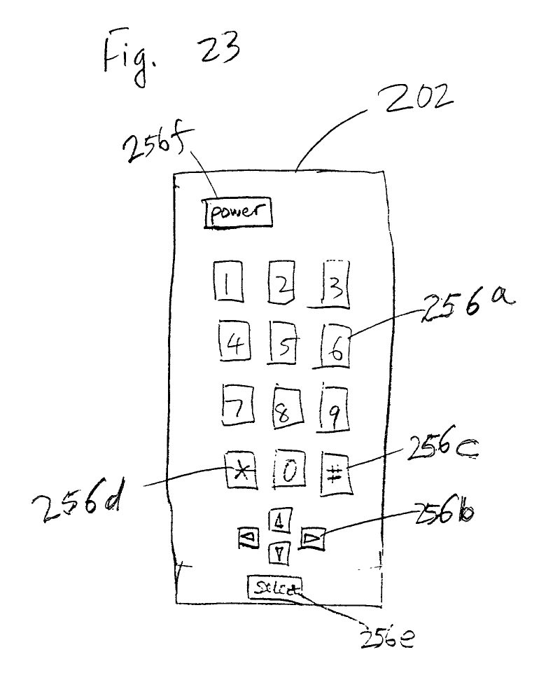

The Internet appliance cooperates with a reduced-keyset user interface device to accomplish all user interface functions. As used in this specification, the term “reduced-keyset user interface device” refers to an input device having a small number of numeric direction and function keys that generates a small set of user interface keystroke signals. The term reduced-keyset user interface device does not include a device that has a full text-entry keyboard. In this specification, “a small number of keys” is understood to mean a set of ten numeric keys, a set of four direction keys, and a limited number (such as 3-5) of function keys. FIG. 23 illustrates the keypad layout of a reduced-keyset user interface device 202, which includes a set of ten numeric keys 256a, four arrow or direction keys (Up, Down, Left and Right) 256b, a Pound key (“#”) 256c, a Star key (“*”) 256d, a Select key 256e, and an On/Off toggle key 256f. Alternatively, the four arrow keys may be replaced by a “joybutton” type of device (input device that has single switches in the cardinal locations instead of multi-value analog sensors). This preferred layout of 18 keys is optimized for ease of use and operation. This key set has the additional advantage that it is very similar to the keypad found on cordless telephone handsets (such as the Star and Pound keys). Of course, the keys on the reduced-keyset user interface device, especially the function keys such as the Pound, Star and Select keys, may be labeled differently without affecting the basic function of the interface device. In addition, more or fewer keys may be used, and auxiliary keys such as shift, control or alt keys may be provided to expand the number of keystroke signals. A keystroke input device satisfies the requirement of a reduced-keyset user interface device so long as it has relatively few function keys and does not have a full set of text-entry keys.

The remainder of this specification describes a graphical user interface (GUI) for a web browser according to embodiments of the present invention, which is implemented in an Internet appliance and uses a reduced-keyset user interface device for user input.

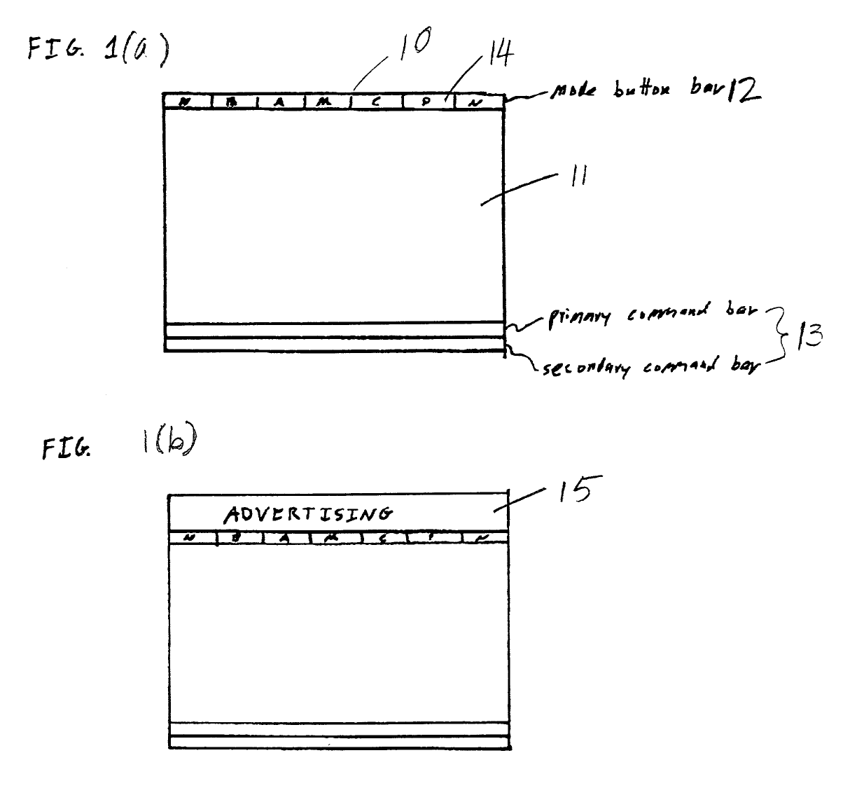

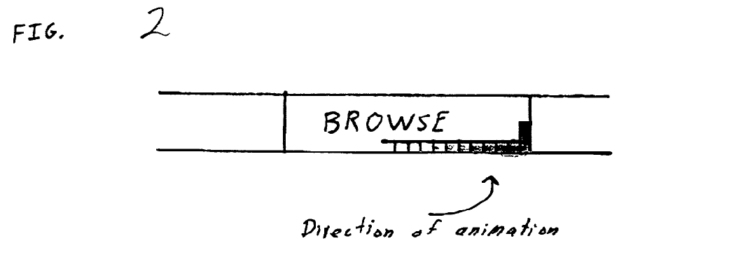

Referring to FIG. 1(a), the display screen of the browser 10 is divided into a primary display 11 area and one or more (or none) horizontal bars 12 and 13 located at the top and/or bottom of the screen. These horizontal bars contain control elements (“buttons”) 14 and are referred to as “button bars”. In the illustrated embodiment, there is a single button bar 12 at the top of the screen. The top button bar 12 is used to select the current mode of the system, and its contents are consistent between all of the different modes and screens that the browser application implements. There are either one or two bars 13 at the bottom of the displays, depending on the currently selected mode. In this example, the top button bar 12 may be referred to as the mode button bar and the bottom button bars 13 may be referred to as the command button bar.

At any given time, only one of the plurality of screen areas 11-13 is active and will interpret user input signals (the input keystroke signals). This screen area is referred to as the input focus area, or as having the “input focus”. The input focus rotates between the button bars 12, 13 and the primary display area 11 when the user presses the Pound (“#”) key on the user interface device. When the input focus is on a button bar, the Left and Right arrow keys are use to change the currently-selected button, and the Select key is used to choose a mode or invoke a command (when the input focus is in the top or bottom button bars, respectively). When the input focus is on the primary area, any interface elements (such as links) available in that area may be similarly selected and invoked using the arrow and Select keys. If an operation represented by an interface element (a button or other interface element) is unavailable, the element is “grayed out”.

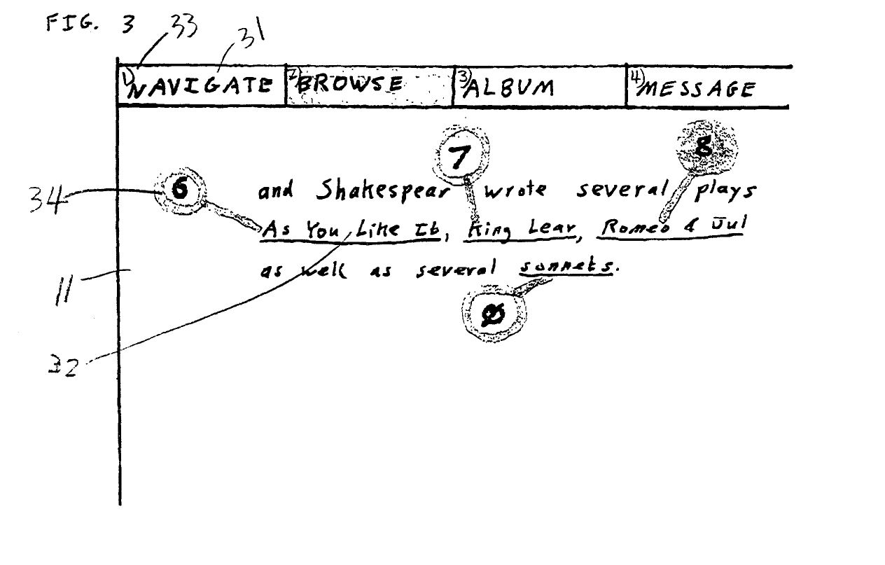

Referring to FIG. 3, control buttons 31 and/or user interface elements 32 in the primary display area 11 may be associated with numeric keys on the reduced-keyset user interface device by displaying a numeric designation 33 or 34 associated with the button or user interface elements. If a command is temporarily unavailable, it is both “grayed out” and redrawn without its associated key symbol. When this is done, another component of the user interface may be temporarily assigned to the same numeric key. Preferably, commonly used commands are always associated with the same keys without being changed dynamically, so that the user may become comfortable with the relationship between keys and commands. Association of interface elements and numeric keys is described in more detail in commonly assigned co-pending patent application entitled “Internet Appliance Using a Reduced-Keyset User Interface Device,” which is hereby incorporated by reference in its entirety.

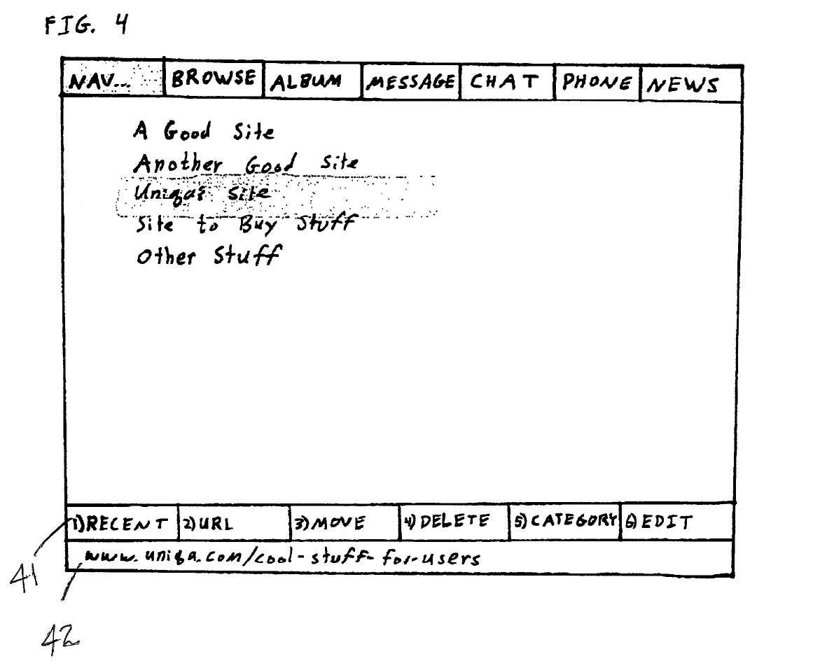

In a preferred embodiment (see FIG. 4), the display has two command button bars, a primary command bar 41 and a secondary command bar 42, displayed at the bottom of the screen. The primary commands are associated with numeric short-cut keys on the reduced-keyset user interface device, while the secondary commands are invoked by using the Pound key to rotate focus to the secondary command button bar and the Left and Right keys to select the desired command.

In addition to the various modes represented by the mode buttons in the top button bar, the web browser is also designed to support advertising content pushed from a server to the client while the client is connected to the network. FIG. 1(b) shows the display screen when the web browser is receiving advertising content. When advertising is displayed, the entire advertising area 15 may operate as a single-button button bar. It is highlighted in succession in the rotation of input focus controlled with the Pound key. When the advertisement area 15 has the input focus, pressing the Select key causes the link associated with the advertisement to be followed, and the browser application automatically changes to Browser mode and displays the content from the HTTP server at the target URL of the advertisement. Alternatively, the advertising area may operate as a second HTML display window. In this case, an ad would consist of an HTML page and all of the in-line data items it references and incorporates. When the input focus is in the advertising area, the user can manipulate its contents using the direction, Select and numeric keys of the user interface device in the same way as the primary screen area in the Browser mode (described later). If the current mode is Browse mode, then the commands in the primary and secondary command bars are active and available; otherwise (if any other mode is the current mode) the commands are all grayed-out and unavailable. When the user finally invokes one of the links that leads to the content being advertised, the link includes a TARGET=“_main” attribute to cause the central screen area pseudo-frame (“-top” when referenced by HTML links already displayed in the central screen area) to be loaded with the target of the link, and the ad area to be loaded with a new advertisement. The content of the advertising area is continually updated with new ads from the server as the user works with the system. The amount of time an individual ad is displayed can be varied, but should always be long enough for the user to decide to stop what they are doing and rotate the input focus to the ad area.

Further, the browser application displays a graphic icon in a designated area of the screen (such as the upper-right corner), and is used either alone or in combination with other indicators on the front panel of the Internet appliance to indicate the current state of the system to the user. The types of status information indicated may include: Whether the system has an established network connection (whether or not data is currently being transferred); whether the system needs to establish a network connection but cannot because the telephone line is in use; whether there is one or more messages that have been received but not yet viewed; and Whether the currently-displayed web page was downloaded using a secure (SSL) link.

Still further, an animated icon referred to as “working icon” is displayed to indicate whether data is being transferred between the browser application and the network. The working icon function may be integrated into the Browse button in the mode button bar (see below), to save screen real estate. When the browser application is exchanging data with the network (e.g., looking up the address of a server, establishing a server connection, fetching data, uploading data, etc.), a “chase” animation is drawn around the edge of the Browse mode button. The animation is done using 2×2blocks of pixels, drawn just within the Button Light/Dark color 3D-effect borders. The blocks are drawn in a number of shades of a new color (Working Color). The darkest block is drawn “leading” the chase animation, with several blocks, in successively lighter colors, drawn following it. While working, the browser application rapidly redraws the series of blocks, each time moving the leading block one position around the border of the button (clockwise or counter-clockwise), redrawing all of the other blocks, and erasing the position previously held by the lightest-color block. The working animation is drawn regardless of the current state and face color of the Browse button. Because browser application is multi-threaded, it is possible for network traffic to be ongoing when the mode bar does not have input focus, when it does and another button is selected, or when the Browse button is selected. The working icon is shown in FIG. 2.

The browser implements several modes, which are represented the button bar at the top of the display screen for the users to select. Each mode provides a different kind of network access, including:

Help Mode—presents context-sensitive help, based on the mode and selection immediately before the user selected Help mode;

Navigation Mode—used to select/input sites/URLs for the browser;

Browse Mode—used to view and interact with content served by an HTTP network server;

Album Mode—used to view and arrange material the user has saved from web sites, messages, etc.;

Chat Mode—used to exchange voice clips with groups of other people through a central server;

Message Mode—used to send and receive Internet messages (e-mail);

News Mode—used to view text messages posted to “usenet” discussion (news) groups; and

Internet Telephone Mode—used for full-duplex point-to-point and conference communication over the Internet.

Other modes may be also provided, such as Exit. In addition to these modes, the browser application also implements a mode similar to Browse Mode but with the absence of the mode button bar, the command button bars, and any scroll bars, intended to be used as the primary user interface of the Internet appliance on which the browser is implemented. This interface is intended to allow navigation between and selection of different resources on the Internet appliance, including a variety of different applications other the web browser application. This is referred to as “Multi-Application Support”.

All of the mode buttons may be displayed at once. Alternatively, when a relatively large number of modes are provided that exceeds the number of mode buttons that may practically be displayed in the top button bar, the modes may be grouped. The groups of modes may be represented to users as multiple different “applications,” accessed each with a subset of the available modes. For example, NAVIGATE, BROWSE, NEWS and ALBUM (and optionally HELP and EXIT) may be packaged together as an information-access application while MESSAGE, CHAT, PHONE and ALBUM (and optionally HELP and EXIT) may be packaged together as a personal communication application. A multiple-application (system) navigation application may be provided for the user to choose between the applications. In the above example, the ALBUM functionality is included in both applications (as well as other applications implemented by the Internet appliance) to allow the user to store data generated by different sources and to use data from one source for any feature.

The display arrangement for several modes implemented by the web browser, as well as the commands associated with each mode, are described now with reference to the figures. The screen layout and list of available commands for some of the modes are summarized, followed by descriptions of the available commands.

The screen display for the Navigation mode is illustrated in FIG. 4. The available commands in the Navigation mode include: 1) RECENT/MARKED/RECOMMENDED, 2) URL/TITLE, 3) MOVE, 4) DELETE, and 5) CATEGORY. These commands are associated with numeric keys of the user interface device for quick access.

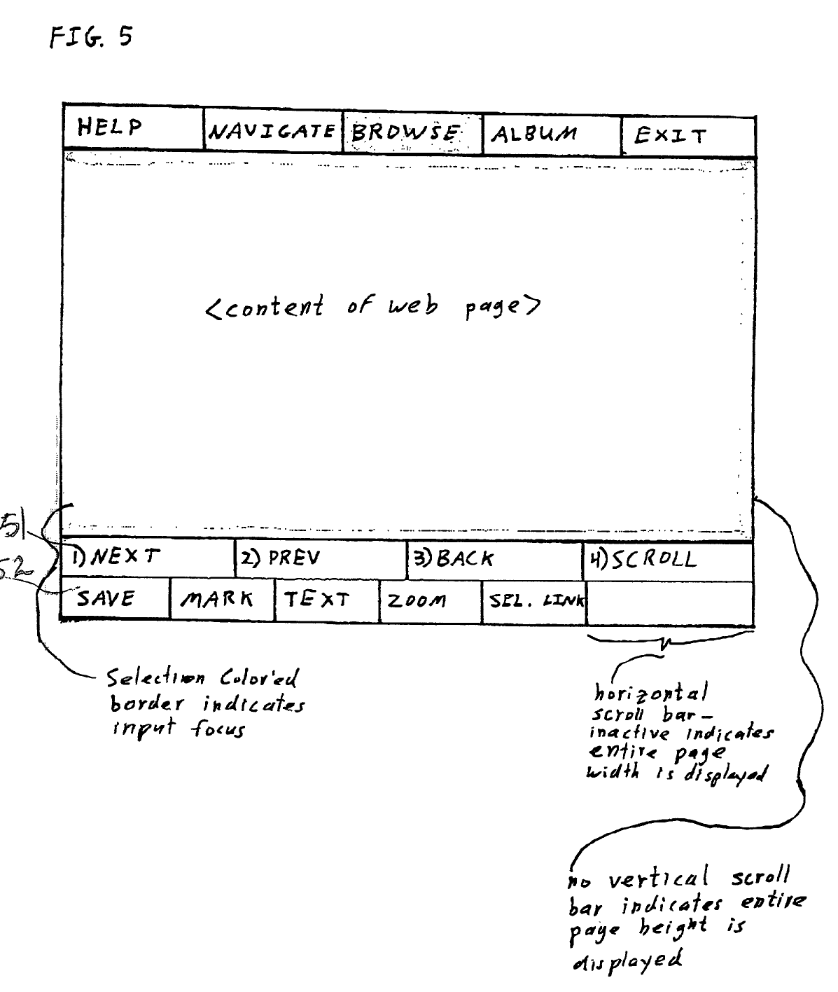

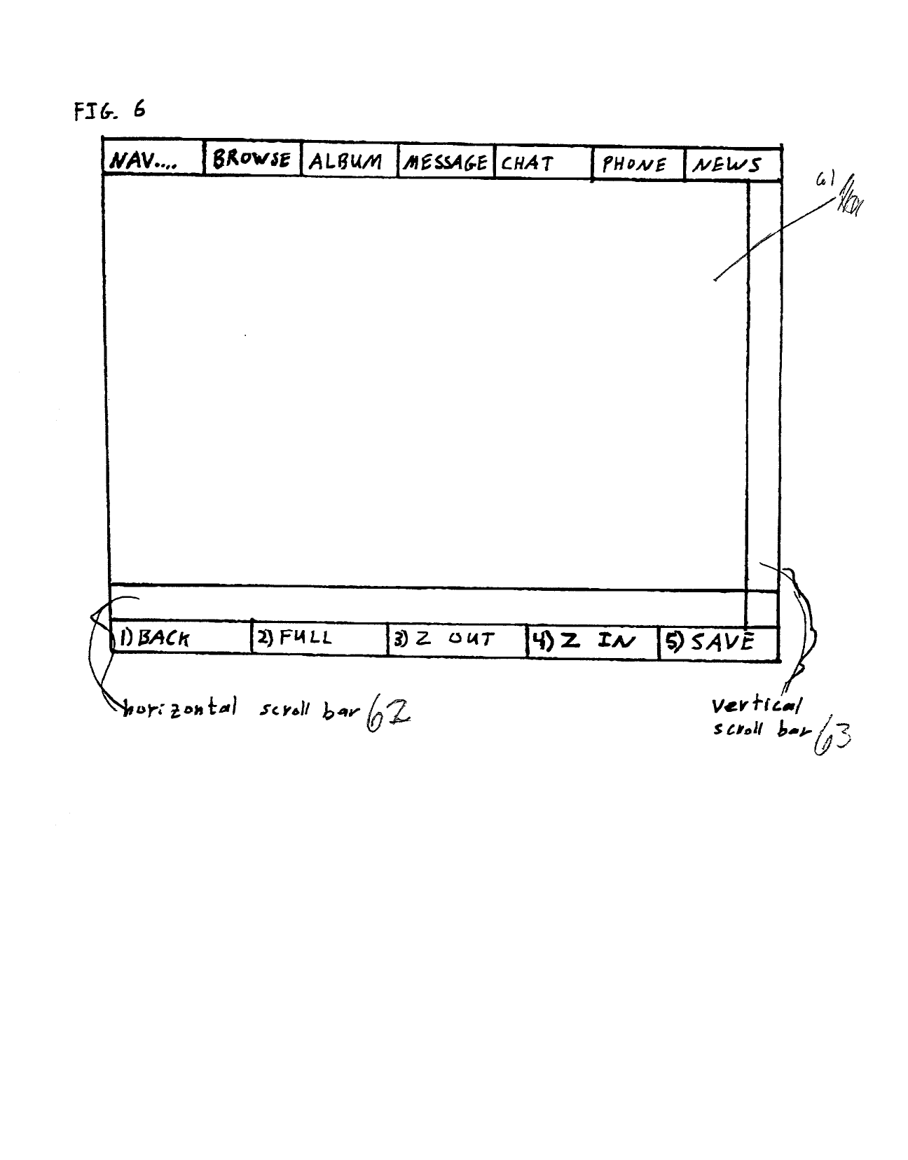

The screen display for the Browse mode is illustrated in FIG. 5. The available commands in the Navigation mode include several commands displayed in a primary command button bar 51 and associated with numeric keys: 1) NEXT, 2) PREV, 3) BACK, and 4) SCROLL. This mode also includes several commands displayed in a secondary button bar 52 and not associated with numeric keys: SAVE, MARK, TEXT, ZOOM, SELECT LINKS/SELECT ALL, and a Horizontal scroll bar. When in the Zoom screen within the Browse mode, a screen display shown in FIG. 6 is displayed, which includes the following available commands: 1) BACK, 2) WINDOW/FULL, 3) Z OUT, 4) Z IN, and 5) SAVE. The primary display area 61 is provided with horizontal and vertical scroll bars 62 and 63.

The screen display for the other modes (Album, Message, Chat, Internet Telephone, and News, Help) may be similarly provided.

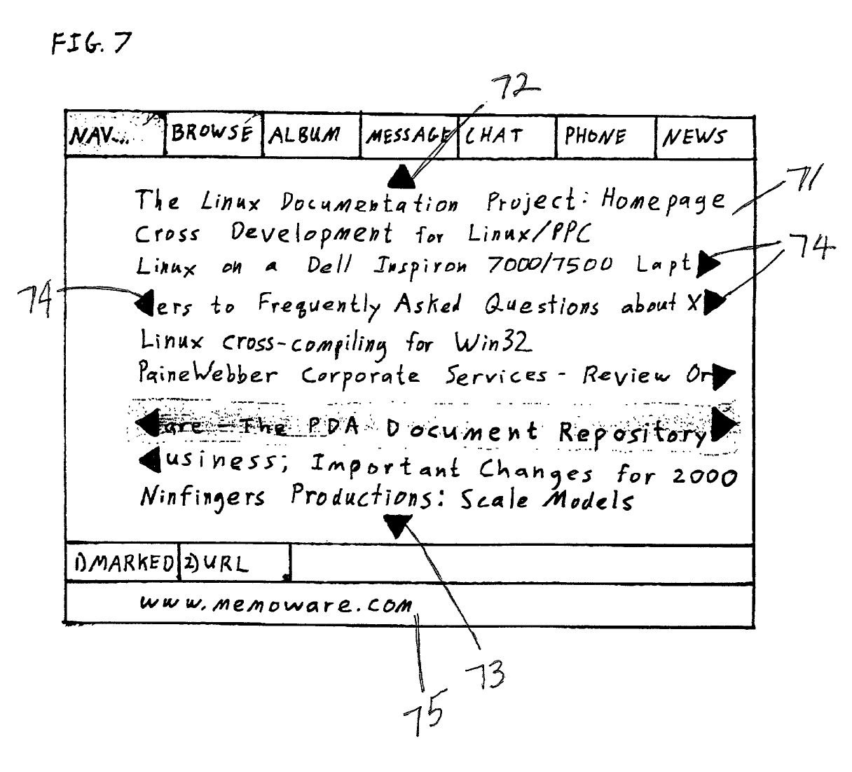

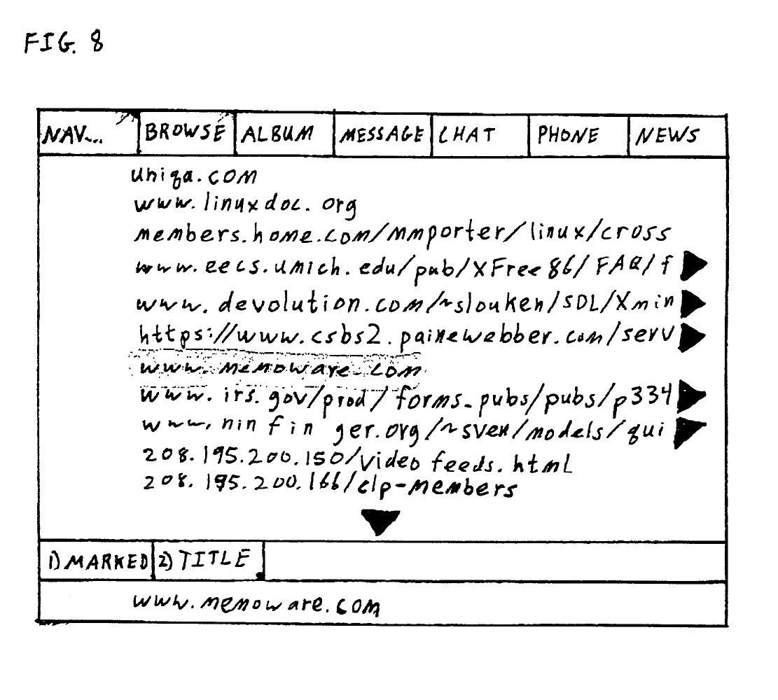

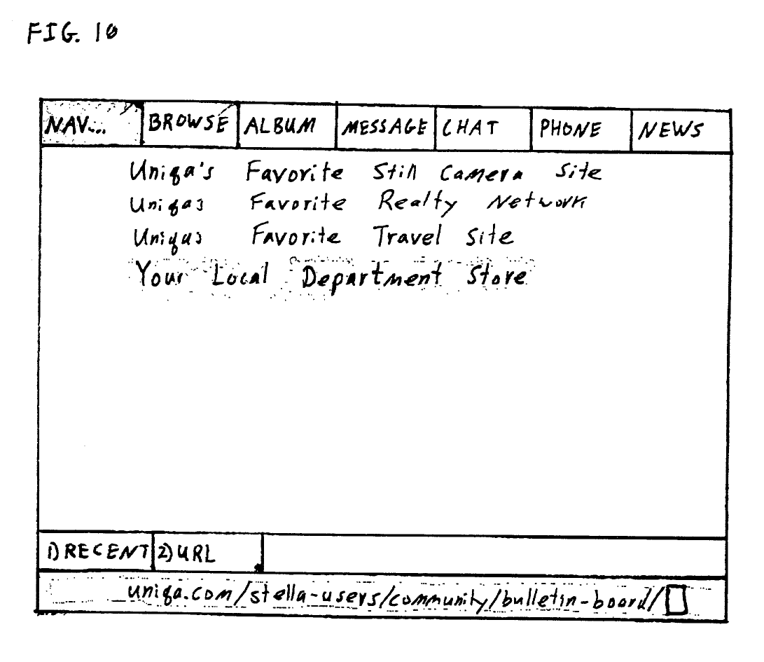

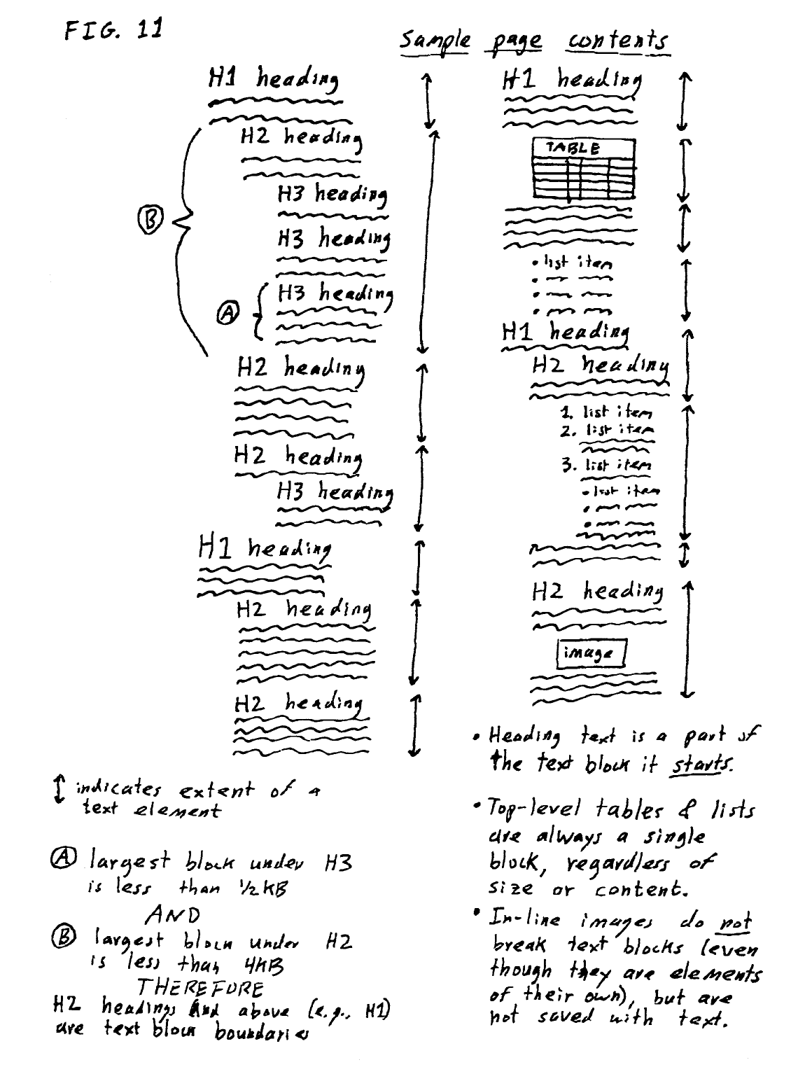

The behavior of the Internet appliance in several modes is described in detail with reference to the figures. FIGS. 7-10 show the Navigation mode and related functions. FIGS. 11-19 show the Browse mode and related functions.

### Navigation Mode and Commands

The Navigation mode allows the user to select the Internet server/service/content that they wish to access using Browse mode. Navigation mode is closely coupled with Browse mode. The mode provides four different ways the user can select the URL (“web site”) to be browsed. First, it provides a list of “recommended” web sites that is updated remotely by an entity having a service relationship with the user, such as an entity providing the Internet access service to the user. The entity may maintain a variety of different lists, and may charge web sites a fee to be placed on a list. Some lists are maintained and pushed to the browser systems on behalf of the customers of the browser, so that the customer controls the entire content of the list for a fee.

Second, the browser automatically maintains a list of recently visited web sites, from which the user can select. The length of this list can be varied, but is expect to be at least three or four vertical screen-fulls, accessed by scrolling. Third, the browser allows the user to store addresses of web sites. The user can hierarchically organize and manipulate this list, and select a web site to view from it. Fourth, the browser supplies a text-entry bar so that users can directly enter URLs. The main operation in Navigation mode is the selection of a destination for Browse mode. When a destination is ultimately selected, the mode automatically changes to Browse. If the user changes from Navigation mode to Browse mode through the mode top button bar, the Browse mode display remains as it was the last time it was viewed.

FIG. 7 shows a screen display in the Navigation mode. In the Navigation mode, the primary display area is filled with a list of possible web sites that can be viewed in Browse mode. There are three separate lists of possible destinations, which are selected between using the RECENT/MARKED/RECOMMENDED command. On the currently displayed list, one list item is always selected (highlighted). When the input focus is on the primary display area, the selected item is drawn highlighted. When the input focus is in another area, the selected item is drawn with its highlight “grayed out”, indicating that it is still the current selection, but cannot be manipulated at the moment. When the input focus is on the primary display area, pressing the Select key causes the mode to change to Browse and the display to be loaded from the selected list item. Pressing the Up or Down keys changes the selection to the list item above or below (respectively) the currently-selected item. The keystrokes are ignored if there is not another item above or below. The list is scrolled vertically if the next item is currently off-screen. Pressing the Left or Right keys scrolls the current selection horizontally, if the width of the list item exceeds the width of the display area. The keystrokes are ignored if the item cannot be scrolled farther.

As shown in FIG. 7, if the list of items extends beyond the top or bottom of what is displayed on the screen, an arrow 72 or 73 is drawn on the appropriate edge of the primary display area. If a particular list item is too wide to be drawn entirely within the width of the primary display areas, small arrows 74 are drawn on the end(s) of the item that are not completely displayed. When the list is initially displayed, the first entries on the list are displayed (i.e., if there are more items on the list than can be displayed, the extra items are all off of the bottom of the display), and the top item of the list is the current selection. When initially displayed, each list entry is left justified, so that its initial (left) end is entirely visible, and any width that does not fit on the display is off of the right edge. Each of the three lists of possible destinations has its own current selection, so that when the user invokes the RECENT/MARKED/RECOMMENDED command to change lists, the browser displays each list with the scroll-states and current selection it had when last viewed.

The command set displayed in Navigation mode depends on the format and contents of the primary display area. On the other hand, the format and contents of the primary display area can be changed by the operation of commands. As a result, there are several alternate sets of the command button bar. The first commands in the bar (the “general” commands) are the ones that control the display contents. They are displayed on the left end of the button bar and are always displayed in the button bar. The remaining commands are specific to a particular display configuration, and change each time the display configuration is changed. The width of the general command buttons is fixed based on the maximum number of commands that will be displayed, and the buttons do not change sizes when the other commands change. The following general commands are provided:

1) RECENT/MARKED/RECOMMENDED—This command determines what list of possible destinations is displayed in the primary display area. Each invocation of the command changes the content of the screen to match the command, and changes the name of the command to the next one in the rotation sequence. When RECENT is selected, the list of the most recently visited URLs is displayed and the command name changes to MARKED. When MARKED is selected, the (hierarchical) list of URLs stored by the user is displayed and the command name changes to RECOMMEDED. When RECOMMENDED is selected, the pre-set list of recommended URLs is displayed, and the command name changes to RECENT. FIGS. 8-10 show the screen displays when the RECENT, MARKED, and RECOMMENDED commands are invoked, respectively.

2) URL/TITLE—This command determines how items in the lists are displayed. When URL is selected, the list of sites is displayed with each entry represented by its URL, and the command name changes to TITLE. For the pre-set site list, the “URL” can be a string provided by Uniqa instead of the actual URL of the site. When URLs are displayed, the browser omits the leading “http://” or “https://” portion of the address, as well as the “www.” server name if present. When TITLE is selected, the list of sites is displayed with each entry represented by the title of the HTML page at the far end of the URL, and the command name changes to URL. HTML page titles are cached when items are placed onto lists, and refreshed when the user views a site.

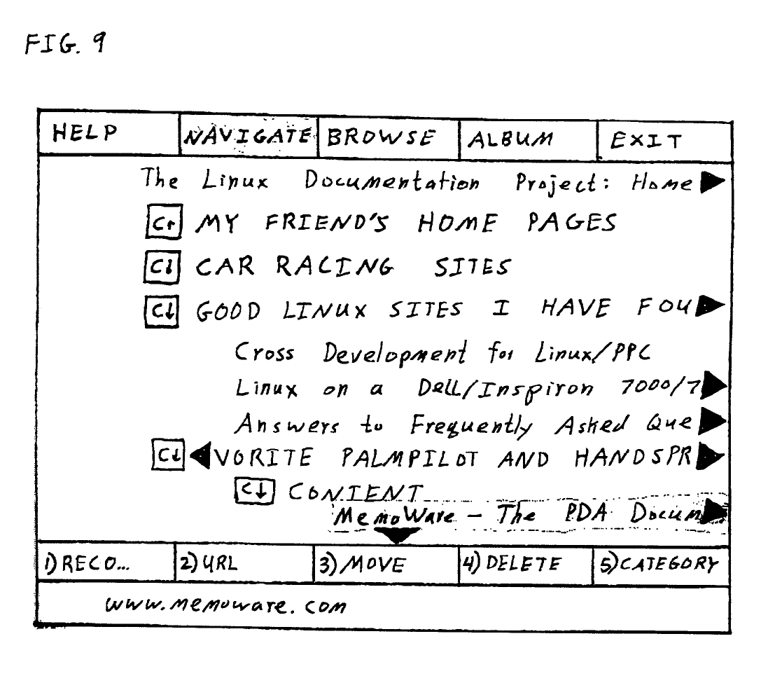

Referring to FIG. 9, when the MARKED command is invoked, additional commands specific to this display allow the user to edit their list of marked (“bookmarked”) sites. New items can be added to this list using the MARK command in Browse mode. The Marked list is hierarchical. The user can create sets of categories, nest them, and manipulate their contents. Category names are distinguished from item names by the following display format: The names of items and categories contained within a category are drawn indented from the left under the name of the category that contains them; and category names are displayed with a special icon at their left end. The icon has two states, one corresponding to a category whose contents are visible and the other for a category whose contents are not currently displayed. Actual list items behave and respond to user interface keys (arrow and Select) as described earlier. However, the behavior of category names is different. When a category name is the current selection, pressing the Select key toggles the display of the contents of the category. Pressing the Up or Down keys changes the selection to the list item above or below (respectively) the currently-selected item, with no effect on whether the contents of a category are displayed or not. Pressing the Left or Right keys scrolls the current selection horizontally. If the name of a category is too wide to display within the width of the primary display area (accounting for indented display), then it can be scrolled horizontally and is drawn with scrolling arrows on the left and/or right end of the name, just like regular item names. However, the area within which the name is scrolled and the arrows can be drawn starts to the right of the category-name icon. The category-name icon is always drawn in the same place (aligned vertically with the left edge of other item names at the same hierarchical level) and does not scroll along with the first characters of the category name.

Other commands available to the screen display of FIG. 9 (MARKED screen) includes: 3) MOVE, 4) DELETE, and 5) CATEGORY. The Move command allows the user to move an item to another point in the list. If a category is moved, all of the items and other categories subordinate to it are moved as well. The item that is selected when the Move command is invoked is the one that will be moved. It is highlighted specially (using a different color from the normal highlight color) and the user is able to change the current selection (and scroll the display) while the Move command is still executing. To complete the Move operation, the user selects a second list entry (item or category name) and then presses the Select key. The item being Moved will then be placed in the list below the item that was highlighted when the Select key was pressed. If the highlighted item was a category name, then the item being Moved will become the first item in the contents of the category. When items are moved into a category, the state of the category is forced so that the contents of the category are displayed. Commands other than Move are grayed-out and unavailable while a Move is in progress. The Move command is left active, and if invoked again it cancels the Move operation and clears the special highlight on the list item that was selected when the initial Move was invoked.

The Delete command removes items from the list. If the selection to be deleted is a category, a dialog box may be presented to confirm whether the contents of the category should be deleted. An item that has been “deleted” is redisplayed in “strike-out” text (with a continuous horizontal bar through the middle of all the characters). When a “deleted” item is selected, the label on the Delete command button changes to Undelete, and invoking the command again will clear the deletion state of the item. If the selection to be undeleted is a category name, a dialog box is displayed to confirm whether the deleted contents of the category should be undeleted. Items marked as deleted are actually removed permanently as part of the “clean up” operations performed following the user pressing the Power key on the interface device in order to make the system idle.

The Category command is used to insert categories into the list. The browser contains an extensive built-in list of category titles. When this command is invoked, a dialog box is displayed, containing a vertically scrolling set of command buttons and a Cancel button. Each button is labeled with one of the built-in category titles, and selecting a button will cause the category title to be inserted in the list below the item that was selected when the command was invoked. If the new category is inserted below an existing category, then it becomes a subordinate category and part of the existing contents of the category.

Alternatives to the Category command may be provided. One alternative is simply to populate the Marked list with the entire set of predefined category names when the systems are initially configured. Subsequently, users would customize their system by deleting those categories they are not interested in using. The second alternative is to provide commands that allow users to create their own category names. For example, a New and an Edit command may be added to or used as a replacement for the Category command. The New command may be used to create a new category. When it is invoked, a dialog box containing a single-line text-entry box is displayed, and the user enters the new category name and presses the Select key to insert the empty category. The Edit command may be used to modify the name of a category. When this command is invoked while a category name is selected, a dialog box with a single-line text entry box is opened, with the text box pre-initialized with the existing category name. When the Select key is pressed, the modified name replaces the original.

As shown in FIGS. 7-10, in Navigation mode, the position of the secondary command bar 75 is taken by the “URL bar”. This contains a single-line text entry box that allows the user to directly enter the text URL for a site. While the input focus is in the primary display area, the URL bar is automatically updated with the URL corresponding to the current selection. When Navigation mode is entered from the Browse mode by the user through the mode button bar, the URL bar is pre-initialized with the URL for the HTML page that was last displayed by Browse mode, and the input focus is directed to the URL bar. When the input focus changes to the URL bar, the text input cursor is automatically placed at the right end of the URL, scrolling it if necessary. The user can replace or modify the text of the URL. Pressing the Select key while the input focus is on the URL bar causes the browser to changes to Browse mode and attempts to load the HTML page.

The Navigation mode described above provides four different ways the user can select the URL to be browsed. Alternatively, a fixed-destination Navigation mode may be provided in lieu of a complete navigation mode. This fixed-destination navigation mode is useful when the Internet appliance is intended to be used to access a specific service or group of services. In this mode, the Navigation mode lists only the destination(s) for which the system is configured. On the other hand, when the appliance is intended to be used as a general interact access system, the complete Navigation mode is provided, which allows the user to input and access any internet (or intranet, if they have access to one) HTTP server. The fixed-destination Navigation mode is a subset of complete Navigation. For example, a fixed-destination navigation systems may contain only the “recommended” web site list as the mechanism for selecting a web site.

### Browse Mode

The Browse mode has different displays that are used to view and interact with content from network (HTTP) servers. The URLs for the content accessed is initially determined through the Navigation mode displays, and subsequently by the links followed from one HTML page to the next. There are two primary displays, the Browsing Screen and the Zoom Screen. The Browsing Screen is used to view and navigate through entire pages of formatted content. The Zoom Screen is used to more closely view individual graphics from the Browsing Screen.

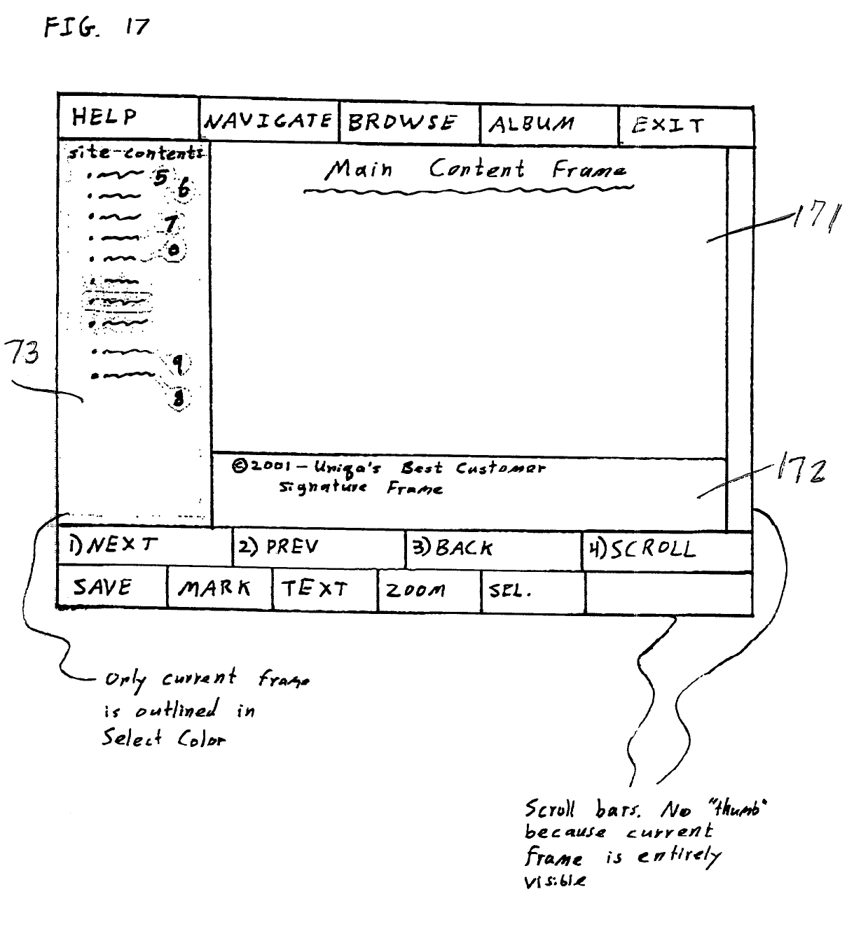

The Browsing Screen is similar to the main window of typical browsers, and displays formatted data from an Internet server. The content from the server is formatted and rendered in this area. Layout is performed primarily according to standard HTML interpretation, except that some images are scaled down to improve layout on the display of the Internet appliance that is smaller than a PC, and to prevent unnecessary horizontal scrolling. However, both horizontal and vertical scrolling are provided. In the case where the HTML content being displayed uses “frames” for layout (see FIG. 17), the primary display area may be divided up, based on the frame directives of the page, into two or more “display regions.” In this case, the input focus is directed to only one of such display region at a time, and is rotated between the display regions using the Star key, similar to the rotation of input focus between the primary display area and the button bars using the Pound key. If there are no frame directives, then the page consists of a single page and the primary display area is the same as the display region.

### Assignment of Page Elements to Keys in Browse Mode

Within each display region of the Browsing Screen, page elements may be associated with (mapped to) keys on the reduced-keyset user interface device for easy browsing. At any particular time, five elements of the contents of a display region are highlighted, including the current selection, and four elements as possible selections that can be reached from the current selection by pressing the four direction keys. The current selection is highlighted, such as surrounded by an outline drawn in a highlight color. The possible selections are highlighted in a different manner, such as surrounded by a broken outline drawn in the highlight color. (For the purposes of drawing these selection outlines, and all other user interface cues superimposed on the page content by the browser, drawing is performed by averaging the drawing color with the colors of the underlying pixels. This provides a “transparent” appearance to the user interface components, preventing them from obscuring the page contents.)

Several factors may determine which items on the display are chosen as the possible next selections and associated with the direction keys. Among these are the current selection mode and the relative positions of the items laid out on the display. First, the current selection mode, which may be either Select All or Select Links, determines the set of page elements that are possible targets for navigation. When the Select Links command has been executed, only hypertext links and form elements can be selected by the direction keys. When the Select All command has been executed, the set of possible target elements includes all parts of the page, including individual blocks of text and images. This allows the user to select elements that are not links, such as for saving or for more detailed viewing in the Zoom Screen display.

If Select All was last executed, then each individual text block on the page is an element that can be selected. Text block boundaries are chosen so that they are as inclusive (generating fewer, larger text blocks) as is reasonable. This is done for two reasons. First, if the user is trying to select something other than text, then the fewer text blocks are created the fewer keystrokes the user requires to select through them to get where they are going. Second, if the user wants to select a text block so that he can save it (described later), it is better if he can get all of the text he wants in a single save operation, rather than having to do a number of smaller operations. With reference to FIG. 11, several HTML tags may form boundaries between text blocks, including all of the tags that introduce in-line data (IMG, etc.), and that begin and end lists and tables. Heading tags (H1 through H6) may or may not bound text blocks, depending on the amount of text between them. The entire HTML page is analyzed, and a particular heading level chosen so that the blocks of text between headings of that level (including lower-level, or higher numbered, headings) are in a desirable range. If the amount of text in a single block under all headers of the same level (after first taking into account other syntax that breaks blocks) is greater than a particular size such as 4 KB (8 KB for a double-byte language), then a lower-level heading is chosen. If the amount of text in all blocks under all headers of the same level is smaller than a particular size such as 512 bytes (1 KB for double-byte languages), then a higher-level heading would be preferred. Preferably, these particular sizes are variable and not hard-coded. If a page contains a block of text greater than 4 KB in length that is not broken by one of the “structural” tags listed above, it may be evenly subdivided into a number of blocks that is a power of two (e.g., a block between 4 KB and 8 KB in length is divided into two, a block between 8 KB and 16 KB is divided into four, etc.). The browser attempts to divide blocks on logical boundaries, first looking for the <P> tag nearest the desired division points, then looking for any block-structure tag. If the text doesn't contain an adequate number of any kinds of block-structure tags, the browser will divide the text block at the white space closest to the desired division points.

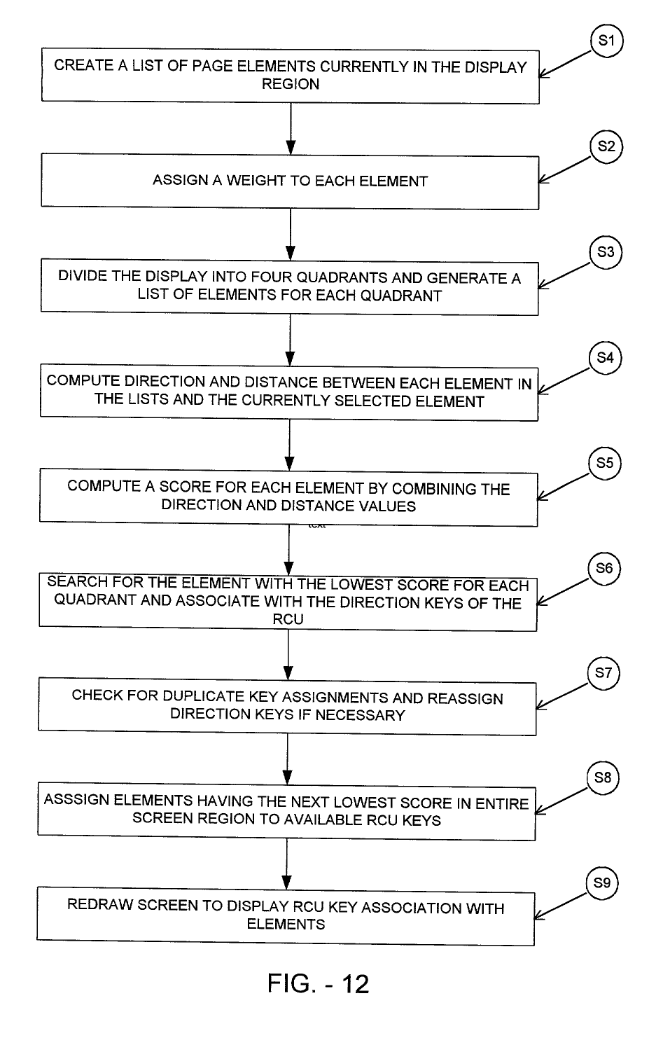

To determine which of the available set of page elements are mapped to the direction keys for a particular currently-selected element, the browser executes the following steps illustrated in FIG. 12. First (step S1), a list is created containing only those page elements that are currently in the display region (partially or wholly), or are within a certain distance, such as 1/10th the dimension of the display region, beyond a display region edge. For example, consider 10 a current page (or part of a page within a frame) that is both wider and higher than the size of the display region, and is scrolled all the way to the left but is in the middle vertically. The elements on the list would include everything that is at least partially within a bounding box that includes the left edge of the display region (and page), a line 10% of the display region height above the top of the display region, a line 10% of the display region height below the bottom of the display region, and a line 10% of the display region width to the right of the right display region edge. Elements outside of the display region are considered so that the user will be able to scroll the screen implicitly by navigating to items beyond the display region borders. If the element associated with a direction key is beyond a display region boundary, a hashed arrow is drawn in selection color at the appropriate display region boundary pointing outward.

Second (step S2), each element is assigned a weight. Most elements are assigned weight values of 1.0. An element that is associated with a command (described later) is assigned a weight of 0.9. In actual implementation of the calculation, fixed-point arithmetic is preferably used for efficiency.

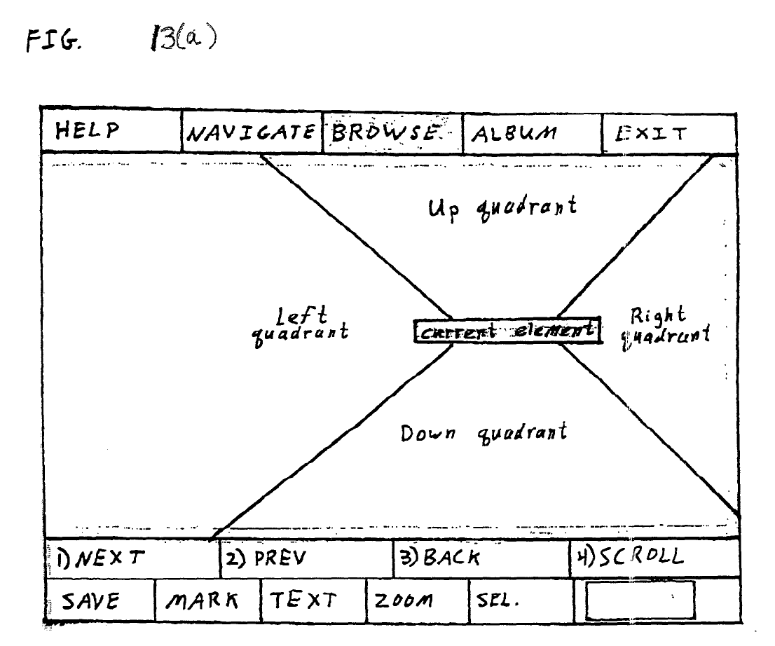

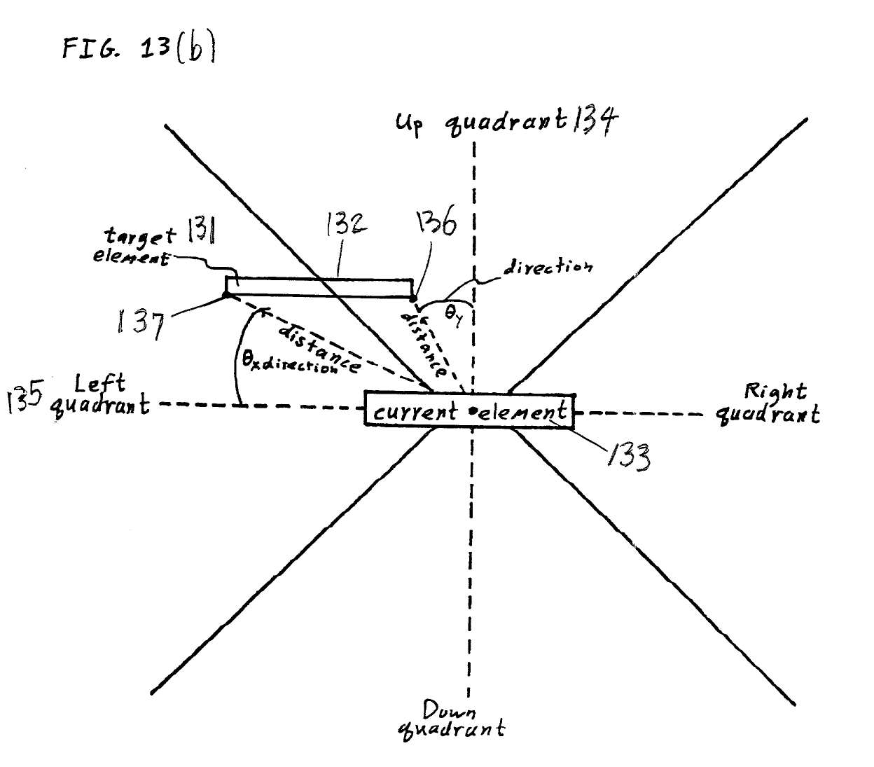

Third (step S3), four separate lists of elements are created from the complete list (the primary list) of elements. The display is divided into quadrants (sub-areas), as shown in FIG. 13(a). Each quadrant is associated with one of the direction keys, and a separate list is created for each quadrant. Elements are copied from the primary list onto the list for a quadrant as long as any part of that element overlaps with the quadrant corresponding to the list. Some elements may be listed in multiple lists. A list corresponding to a quadrant may also be empty when this process is complete, which means that the user has reached the edge of the display region and the direction key corresponding to the quadrant will have no effect.

Fourth (step S4), the direction and distance between each element on each list and the currently-selected element is computed. As shown in FIG. 13(b), when performing this computation, the location of a target element 131 is considered to be the corner of the bounding box 132 of the element closest to the currently-selected element 133. For example, consider a target element 131 that straddles the boundary between the Up and Left quadrants 134 and 135 shown in FIG. 13(b). When computing the direction and distance of the element 131 for the Up quadrant 134, the lower-right corner 136 of the bounding box 132 of the element is used for the computation. When computing the direction and distance of the element 131 for the Left quadrant 135, the lower-left corner 137 of the element is used.

Fifth (step S5), a score value is computed for each element on the list of each quadrant by combining the direction and distance information. If the direction vector from the currently-selected element to the element being considered is exactly horizontal or vertical so that it bisects a quadrant, then the score value is equal to the distance. For other directions, the distance is increased by an amount proportional to the divergence between the direction vector and the horizontal/vertical axes, such that scores for elements whose vectors lie on quadrant boundaries (i.e., are 45 degrees from the horizontal and vertical) are equal to twice their distances. The computed score value is then multiplied by the weight of the element.

Sixth (step S6), the list for each quadrant is searched for the element with the lowest score. This element is then associated with the key for that quadrant. In the event that scores are tied, the element whose direction is closer to horizontal or vertical is chosen.

Seventh (step S7), the browser checks to see if the same element is chosen to be associated with multiple direction keys. If this has occurred, the key assignment for the element having the lowest score is unchanged, and the other direction key is associated with the element in the corresponding quadrant that has the next lowest score in that quadrant.

Eighth (step S8), after all four direction keys have been assigned to page elements, the four quadrant lists are merged into a single list while keeping multiple entries for the same element if they have different scores for different quadrants, and the single list is sorted again by score. The lowest scoring N elements are then chosen and assigned to otherwise-unused numeric keys. N is the number of numeric keys (10) less the number that are assigned to currently available commands.

Ninth (step S9), the screen is redrawn to indicate the associations between the keys and page elements.

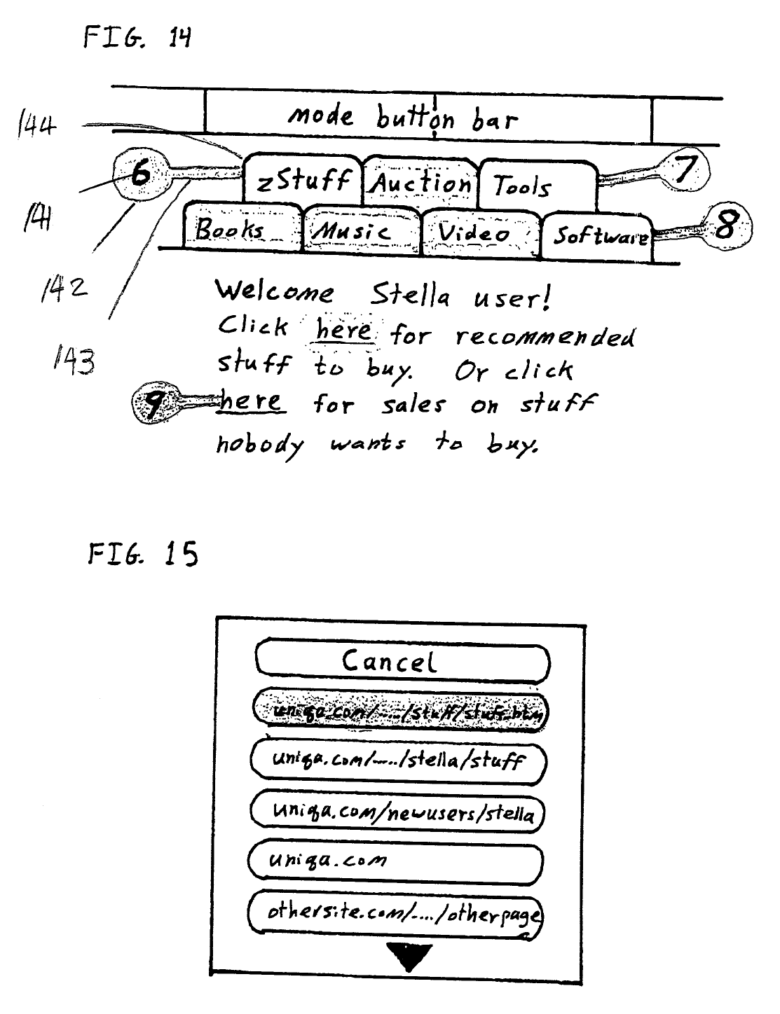

In the redrawn screen, the currently-selected element is outlined with a rectangular bounding box drawn using 2-pixel wide lines in the Selection Color. The visible page elements associated with direction keys are outlined with rectangular bounding boxes, drawn using “dotted lines” formed of 2×2pixel squares in the Button Light color. Any direction keys associated with page elements that are outside of the central screen area (or not yet associated with anything, see the special case below) are indicated by arrowheads drawn against the center of the edge of the central screen area which the element is beyond. For example, if the element associated with the Down key is beyond the bottom of the central screen area, a downward-pointing arrow head is drawn against the bottom edge of the central screen area in the horizontal center thereof. As shown in FIG. 14, the association of keys with page elements is depicted by drawing the numeral 141 of the key as a label (e.g. in an Active Control Text color) over a circular background 142 (e. g. in a Button Light color), with a lead line 143 (e.g. in a Button Light color) linking the label to the page element 144 with which the numeric key is associated. Preferably, the label is positioned in white space areas of the page (i.e. areas having no information displayed). All outlines, labels, circles and lead lines are drawn transparently (e.g. by averaging pixel values) over the page content. Of course, other drawing styles may also be used to indicate key assignments to screen elements.

When drawing selected links and interpretation of ALINK HTML attribute, the select color is transparently added only to the background color against which the text of the selected link is drawn. The link text itself is drawn with the “selected link” color (default or as specified by an ALINK attribute) without blending in the selection color.

If, after the above process (steps S1-S9 of FIG. 12), one or more of the direction keys has not been assigned to a page element, it will be treated as a “target-less” scroll command for its direction. When such a direction key is pressed by the user, the central screen area is scrolled a predetermined amount, such as 50% of its extent in the corresponding direction, or scrolled all the way if the content of the current page does not extend sufficiently far. After scrolling, the browser redraws the screen. The display is then searched for a selectable page element. The element that has a bounding box corner that is closest to the center of the display is chosen and redrawn as the current selection. Then, the process described above (steps S1-S9) is used to assign keys to any other page elements. If there is no selectable element anywhere in the display, then there can be no keys assigned to page elements, and scroll arrows will be drawn at each screen edge beyond which additional page content may exist.

When laying out the contents of an HTML page for display, the browser pre-computes the complete set of mappings from each display element to the four elements to which the selection can move. This information is analyzed to ensure that every element can be reached from at least one other element. If this is not the case, the weighting for the element(s) that cannot be reached is increased, and the entire set of mappings recomputed. This process is iterated until a set of mappings is achieved that allows navigation to all elements.

Once the keys are mapped, the keys may be used to move around the page in the following manner. When one of the direction keys (Left, Right, Up, or Down) is pressed, the currently selected page element is updated to the element associated with the direction key that was pressed, causing the association between direction and numeric keys and page elements to be recomputed and redisplayed. If the page element that is to be selected is not displayed (at least in part) in the central screen area before the key was pressed, the display will be scrolled so that it is displayed. If the extent of the page element is smaller than the central screen area, then the display is scrolled (horizontally and/or vertically, as appropriate) so that the page element is centered within the central screen area. If the element does not fit entirely within the central screen area, then the display is scrolled so that the portion of the element “opposite” to the direction of the key press is displayed, starting 10% away from the corresponding page edge. For example, if the newly-selected page element is taller than the central screen area, and was “above” the top of the screen before the user pressed the Up key, then the page is scrolled so that the bottom of the element is 10% of the height of the central screen area away from the bottom of the central screen area.

When the Select key is pressed, the browser responds in one of several possible ways depending on what type of page element is currently selected. If the currently-selected page element is an HTML link, then the browser fetches a new page from the URL specified in the link, and redraws all or part of the primary display area with the result. If the currently-selected page element is a form/input control, then the control is selected and the input focus and all key input is temporarily transferred to the control. The subsequent effects of key presses depend on the particular type of control (as described later in connection with interpretation of particular HTML directives). If the currently-selected page element is a non-link graphic image, which will only occur after the Select All command has been invoked, then pressing Select executes the Zoom command. If the currently-selected page element is another type of non-link element, which will occur after the Select All command has been invoked, then pressing the Select key has no effect.

When a numeric key associated with a page element is pressed, the browser responds in the same way as when the user moves the current selection to the page element and then presses the Select key, as described above. In the above example, the numeric keys assigned to command buttons, the Pound key, and the Star key have constant functions while the input focus is in the primary display area.

### Commands in Browse Mode

The commands available in the Browse mode include 1) NEXT, 2) PREV, 3) BACK, and 4) SCROLL. The Next command is a navigation short-cut. The browser will attempt to identify one outgoing link from the currently-displayed page that can be considered a “next page” link. If the page contains a link explicitly marked as the “next” link (REL=“Next” modifier in the LINK tag), it is chosen. Otherwise, the browser scans all of the text between each <LINK> and </LINK> directive pair and attempts to find the one most likely to be the “next” link of the page based on the phrasing. The browser may contain entirely different search routines for each page language that is supported. If no likely “next” link is found, the Next command is grayed-out and unavailable while the page is displayed, and its associated numeric key may be assigned to another page element in the current display region. If a “next” link is found, the Next command is active whether or not the identified link is currently displayed or scrolled off screen. The Prev command is similar to the Next command, except that the browser attempts to find the “back” or “previous” link of the page. Explicitly marked previous links have a REL=“Previous” modifier in their LINK tag.

The Back command is associated with a stack that the browser maintains of all of the URLs the user has viewed. Each time a new page is loaded in the Browsing Screen, either as the result of a choice in Navigation mode or from following a link in Browse mode, the URL of the page is pushed onto the stack. When the back command is executed, the URL of the current page is popped from the stack and discarded, and the browser displays the page specified by the new top entry on the stack. The Back command is grayed-out and unavailable if the currently-displayed page is the first page displayed after the browser has initialized. The browser may also provide a “Forward” command or associated stack of pages from which the user has gone “Back”.

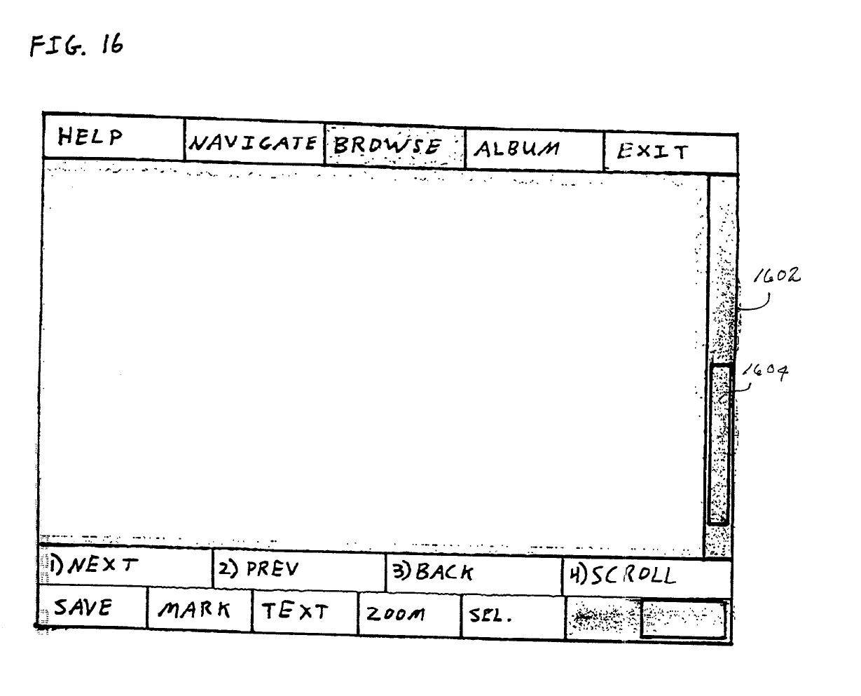

The Scroll command allows the user to scroll the contents of the current display region explicitly, rather than implicitly by navigating the currently-selected page element beyond the borders of the display region. When the Scroll command is invoked, the horizontal and/or vertical scroll bars that are active are redrawn with the selection color, and other selection-color items are “grayed” to represent that the input focus has been transferred to the scroll bars themselves. A scroll bar is “active” when the page data exceeds the size of the display region in the dimension corresponding to the scroll bar. If neither the horizontal nor vertical scroll bar are active, then this command is grayed-out and unavailable. When input focus is in the scroll bars, see FIG. 16, the direction keys cause the contents of the current display region to be scrolled in the appropriate direction, and the Select, Star and/or Pound keys end scroll mode and return the input focus to their previous state. The numeric keys are ignored.

When the contents of the display is scrolled, the currently-selected page element remains selected as long as any portion of it remains visible. The assignment of keys to page elements is recomputed following each scroll operation. If the selected page element is invisible following a scroll operation, a new element is selected. If there are one or more selectable page elements displayed in the central screen area, the browser selects the one closest to the center of the display (based on the bounding box corner of the element that is closest to the center) to be the default currently-selected element. If there are no elements, the browser handles it as described above for implicit, direction-key caused scrolling.

Preferably, all scrolling code for Browse mode, including explicit scrolling and implicit scrolling caused by movement of the current-selection between page elements or in the Zoom Screen, is computed by the same method. For each scrolling case, the code preferably contains three #define constants provided to this function, including a percentage, a number of pixels, and a bit to select which should be used.

Other commands also available in the Browse mode include: SAVE, MARK, TEXT, ZOOM, SELECT LINKS/SELECT ALL, BACK MENU, and Horizontal scroll bar. In order for the user to take information from a web page or from any other display mode and use it in another part of the browser, it must first be saved so that it is accessible in Album mode, and then can be further manipulated (for example, sent as part of an e-mail message). The Save command saves to a remote storage server the currently-selected page or page element. When this command is executed, data is copied to one or a set of file(s) on the storage server which represent a new data item in the “incoming” data Album of the user (described later). The user can subsequently view the data item using Album mode. What is saved in the Save mode depends on the current selection, context, and the last-invoked SELECT command. If the last invoked command was Select Links, then any save operation saves the entire page, including the frame layout, the HTML source filling all of the frames, and all in-line data files referenced by the HTML. If the Select All command was last invoked then only the currently-selected page element is saved. When the information saved is a block of text, simple HTML formatting directives are retained and other HTML directives (but not the text between them) are filtered out. Automatically generated text such as heading numbers, list item numbers and bullets, etc. are embedded into the saved text as-is, rather than saving the formatting directives. When text is displayed by Album mode, the simple formatting directives are interpreted.

The Mark command adds the URL for the currently-viewed page to the Marked (bookmarked) list of the user. The Text command allows the user to alter the font size used for “normal sized” text in the display. The browser interprets all of the HTML formatting tags that effect font size as increases or decreases from the base size that is set with this command. When this command is invoked, a dialog box is displayed. This box contains a vertical stack of buttons, each labeled with text of a different size. The button labeled with text matching the current setting of the browser is selected by default. The Zoom command is available only when the currently-selected page element is an image or video element. When invoked, this command causes the display to change to the Zoom Screen. The Select Link/Select All command is used to toggle the set of page elements that can be selected, as described earlier. This Back Menu command causes a dialog box to be displayed containing the contents of the URL stack, as shown in FIG. 15. It is displayed with a “Cancel” button at the top of the list, followed by the top item from the stack, starting with the URL immediately previous to the currently displayed page, and may be scrolled vertically. When the user selects a URL from the menu, all of the URLs above it on the stack are popped and discarded and the browser displays the page specified by the new top entry on the stack. The Horizontal scroll bar is not a command button, but is placed in the secondary button bar to avoid using screen area elsewhere. This scroll bar indicates whether the content of the current display region is wider than is currently visible, and if so what fraction of the content is on- and off-screen. The user can manipulate the horizontal scroll bar directly only by using the Scroll command.

A vertical scroll bar 1602 shown in FIG. 16 may be provided if necessary. The vertical scroll bar occupies the right edge of the display, extending from the bottom of the mode bar to the top of the primary command bar. The vertical scroll bar is drawn as a typical, PC-like, scroll bar, with a “box” 1604 drawn within the bar, where the fraction of the scroll bar occupied by the box is the same as the fraction of the content of the display region that are currently visible, and the position of the box within the scroll bar corresponds to the position of the visible content within the total content. The scroll bar is updated each time the current display region is scrolled vertically. The user can manipulate the vertical scroll bar directly only by using the Scroll command. If the content of the page is not taller than the current display region, the vertical scroll bar is not drawn, and the full width of the display is part of the primary display area. If the primary display area is divided into multiple display regions (e.g., the display is controlled by an HTML frameset), the vertical scroll bar is displayed if the content of any of the display regions is taller than the region. This prevents the width of the display from changing due to the vertical scroll bar being drawn and removed as the input focus rotates between display regions.

### Interpretation of HTML Directives in Browse Mode

As mentioned earlier, particular HTML directives have effects on the screen layout of the browser and particular user interface effects when page elements produced by particular HTML syntax are selected.

One category of simple HTML directives is handled by the browser in a standard manner known in the art. This category includes: B, BIG, I, SMALL, S, SUB, SUP, TT, U, ABBREV, ACRONYM, AU, CITE, DEL, DFN, EM, INS, KBD, LANG, PERSON, Q, SAMP, STRONG, VAR, ADDRESS, BLOCKQUOTE, CODE, CENTER. They are handled in the same way for various modes of the browser, including Browse and Album modes. One category of complex HTML formatting directives is also handled in an entirely standard manner known in the art. This category includes: General directives: HTML, HEAD, HTML-format comments, BODY, PRE, LINK, A, BASE, H1, H2, H3, H4, H5, H6, BLINK, BR, DIV, NOBR, WBR, P, HR, SPAN, FONT, BASEFONT; table formatting directives: TABLE, THEAD, TBODY, TFOOT, CAPTION, TR, TD, TH, COL, COLGROUP; and list formatting directives: DIR, MENU, HL, UL, OL, LI, DL, DT, DD.

For page title, if an HTML page contains a TITLE directive, the title string is displayed at the top of the contents of the display region of the page. If the display region is scrolled vertically, the title can scroll off the top. The title is separated from the body of the page with a unique horizontal rule, that is drawn differently from that produced by the HR directive or from the horizontal lines in frame borders. Page titles are always drawn centered, as if bracketed with <CENTER> and </CENTER> tags.

For form input directives, the browser implements all of the HTML FORM syntax for sending user-input data to a server. The functioning of the input controls is modified to account for input from the user interface device. Input controls are always selectable page elements, regardless of which SELECT command was last invoked. When the current selection is an input control, the user can press the Select key to direct input to the control. From this point on, the interpretation of following key events is performed by the selected control (e.g., the control has the input focus) until a key causes focus to revert to the current display region. For purposes of navigation (after the Select All command) and for saving data, the entire contents of a page between <FORM> and </FORM> tags is considered a single text block. When such a block is saved as text, the embedded edit controls are discarded and only their current values saved. The function of various input control is described below.

General form tags in HTML that organize the controls in a form (FORM, LABEL, FIELDSET, LEGEND) are interpreted in a standard manner and do not create separate page elements that can be selected after the Select Links command is invoked.

TABINDEX sequence numbers attached to page elements are in two ways. First, when the user completes an operation with an input control and input focus returns to the current display region, if the input control has a tabindex value, then the current selection automatically moves immediately to the page element with the next sequential tabindex value. Second, Tabindex information over-rides the browser's automatic selection of the page elements that should be associated with the direction keys. If the currently-selected page element is part of a tabindex sequence, then the preceding and succeeding elements in the same tabindex sequence will always be associated with two of the four direction keys. Mrffich keys are assigned to the one or two elements depends on the quadrant(s) within which the elements lie. If two elements lie within the same quadrant, the one which is closer to being directly horizontal or vertical of the current element is assigned to the quadrant's direction key and the other is assigned to one of the remaining keys based on the half of the Cartesian plane within which the element is located.

TEXT and PASSWORD controls (INPUT TYPE) operate a similar way as the singleline text entry boxes used in dialog boxes and the URL Bar in the Navigation mode. When the user has finished inputting/editing, he presses the Select key and input focus returns to the surrounding display region.

For CHECKBOX controls (INPUT TYPE), when the currently selected page element is a checkbox and the user presses the Select key, the state of the checkbox is toggled and input focus remains with the surrounding display region. Input focus is never actually assigned to a checkbox control.

A group of RADIO controls (INPUT TYPE) buttons is treated as a single page element for purposes of navigation and selection with the direction keys. Once the user has selected a group of radio buttons, they receive the input control, and each individual radio button is then treated as a page element. The default currently-selected element is whichever radio button is currently selected (or the first radio button if none are selected). While the radio button group has the input focus, the direction keys are used to move the current selection from one radio button to the next. The browser uses the same algorithm to determine the assignment of radio buttons to direction keys that it uses for general page element navigation. If the user presses the Star or Pound keys, the input focus is returned to the surrounding display region and the state of the radio button group is unmodified. When the user presses the Select key, the currently-selected radio button becomes active (selected) and the input focus is returned to the surrounding display region.

SUBMIT, BUTTON, RESET, and IMAGE controls (INPUT TYPE) are treated as buttons. When the currently-selected page element is a form button and the user presses the Select key, the appropriate action for the button is taken. Like other buttons, they do not receive the input focus.

SELECT controls implement “drop-down” selection boxes in PC-type browsers. When the user presses the Select key over a SELECT control in the browser, a dialog box is presented. The dialog box contains a vertically-scrolling group of buttons headed by a cancel button, with one button for each possible user choice. The buttons are ordered in the dialog in the same order they are included in the HTML page description (OPTION tags), and the current value of the SELECT control determines the button selected by default when the dialog box is displayed. The user changes the selected value using the Up and Down keys, and a new value is accepted when the Select key is pressed. If the SELECT control has the MULTIPLE modifier (indicating that more than one value may be simultaneously selected), an “OK” button is added to the top of the button list in the dialog. The user may press the Select key any number of times with any number buttons selected. Each press of the Select key toggles whether or not the value of the button is selected. The dialog box is closed and the new values accepted when the OK button is selected and the user presses the Select key.

A TEXTAREA control is logically a single-line text edit control that is physically wrapped across multiple lines. The textarea control operates exactly the same as a singleline edit control except that instead of scrolling horizontally, the line is wrapped. When the cursor point moves past the right end of the bottom line, the contents of the control scrolls up one line, or when it moves past the left end of the top line, the contents scroll up one line. Arrows are displayed at the top and/or bottom edge of the control to indicate when the control's contents extend beyond the respective edge of the control. Textarea controls in the browser do not have vertical or horizontal scroll bars. Also, since a reduced-keyset user interface device does not have an ability to input a newline character, the browser always automatically wrap and ignore the NOWRAP modifier.

HIDDEN controls (INPUT TYPE) are used to pass data from one script to another through a page, and are not displayed. The browser handles these normally as known in the art.

FILE controls (INPUT TYPE) are handled differently than a conventionally PC-style browser, where a file-upload control is indicated with a text-edit box (for the local file path) and a “Browse” button. In the browser of the present embodiment, the Album mode is used to organize the storage of user files, rather than a traditional “file system”. File-upload controls are indicated by thumbnail-resolution images representing the item(s) selected from the Album mode. When a file-upload control does not yet have any associated data item(s), it is drawn as a grayed-out gray block. When the user presses Select while the currently-selected page element is a file-upload control, the user is automatically moved to the Album mode displays. When used in this context, the SEND command button is relabeled UPLOAD, and when the user invokes this command, the selected item(s) are associated with the upload control and the user returns to the Browse mode. While the browser is in this operating mode, all of the controls in the mode (top) button bar are grayed out except for BROWSE and ALBUM. If the user returns to the BROWSE mode through the mode button bar, it is interpreted as an abort of the file-upload operation: the Browsing Screen display returns to its previous contents and the mode button bar returns to being fully functional.

VOICEGRAM control (INPUT TYPE) is an HTML extension provided by embodiment of the present invention. This control allows the user to record audio (typically a voice message) that will be included with the other data as part of the form submission. In order to use this type of control (as with FILE), the data must be submitted using a Mime Content-Type of multipart/form-data. When a control of this type is the current selection and the user presses the Select key, the browser either records a voice-gram or plays a previously-recorded, as determined by the user. The browser uses a sequence of dialog boxes to manage voice-grams. Each separate VOICEGRAM control in a form and in a page is capable of capturing and storing an independent audio clip.

The use of FRAMESET directives is supported in the browser to divide the primary display area into a set of display regions. In one embodiment, the browser does not support the dynamic creation of new browser “windows”. Instead, a frame TARGET directive that would indicate the creation of a new window in another browser will cause the browser to leave the current frames environment and redisplay the entire primary display area based on the new page data. Use of the Back command will restore the previous display. FIG. 17 shows a sample browse display with frames 171-173. The frame 173 is shown to have input focus.

Server-Side Image Maps are handled in a special manner. Because the browser does not use a mouse pointer, it does not automatically have available a particular pixel coordinate within an image that the user has selected, as is the case in a PC-based browser. In the browser, when the user Selects a link image that is marked as a server-side image map (with the ISMAP modifier in its IMG tag), the input focus is transferred to the image itself. The browser superimposes a grid (such as 10×10 pixel squares, or rectangles) on the entire image in “transparent” selection color and places an “X” in the center square of the grid. In this mode, the four direction keys move the “X” cursor within the grid over the image. When the Select key is pressed, the browser attempts to load a new page from the URL of the link, sending the coordinates of the image pixel in the center of the grid square last selected by the user.

Client-Side Image Maps are treated similarly to most form controls and to serverside maps. They are treated as page elements for selection and can be selected. Once the user has selected a client-side image map, the active areas (defined by the AREA directives) are outlined with dotted lines in the selection color. One of the areas (near the center of the image map) is outlined with a heavier solid line, and is the currently-selected area. The direction keys are used to change which area is selected. When the user presses the Select key again, the browser transmits the selected area to the server and requests the URL associated with the selected area. An alternative way to handle client-side image maps is to treat each region of the image map as a selectable page element all of the time, rather than only after the user has selected the image. The advantage of this is to make image maps stand out more and be more clearly marked as part of the navigation of the page. A disadvantage of this alternative is that it would increase the number of selectable page elements and therefore reduce the speed of navigating through the page to other elements.

Server Authentication is also supported. When a server requests user authentication, the browser displays a dialog box containing two text-entry boxes, an OK button and a Cancel button. The arrow keys select one of the four controls in the dialog box. Pressing the Select key on a text-entry box gives the box the input focus, allowing strings to be entered. Pressing the Select key again returns focus to the dialog box. When the user presses the Select key while the OK button is active, the authentication information is sent to the server.

“Voicegram:” scheme URLs is provided by embodiments of the present invention. Most links in an HTML page indicate another resource located on a web server, and indicate the HTTP storage “scheme” such as http://. . . Other schemes are also used for URLs. In particular, the “voicegram:” scheme uniquely provided by embodiments of the present invention is a mechanism used for the transmission of voice-grams from a client to a server. When the user attempts to follow a link whose destination URL uses the “voicegram:” scheme, the browser records and transmits a voice-gram, and leaves the current page displayed in the central screen area. The voice-gram is recorded with the following sequence of dialog boxes. First, a dialog box is presented to record the voice-grain, with START and STOP buttons and an indicator of how much data has been recorded. Following the link may be aborted by the user selecting STOP before he has selected START. Second, when recording the voice-gram is complete (user has selected START and then STOP), a second dialog is displayed. This dialog has the following buttons: PLAYBACK, RE-RECORD, TRANSMIT, and CANCEL. If TRANSMIT or CANCEL are selected, the dialog box is cleared and the operation is complete. If RE-RECORD is selected, the browser returns to the first step. If PLAYBACK is selected, the browser proceed to the next step. Third, a dialog box is displayed allowing the user to control the playback of the recorded sound, it contains a percent-complete indicator and a STOP control. When STOP is selected or playback completes, the browser returns to the second step.

One way to send a voice-grain to a server and cause a new page to be loaded is by using a form containing an INPUT tag of type VOICEGRAM or by using a link with the ISVOICEGRAM attribute. It is possible to create a tag that produced an all-in-one control that recorded and sent a voice-gram (such as a link with a voicegram: URL), and that also causes a new page to be retrieved via HTTP. This tag is superior to a form with a voice-gram control in that a separate SUBMIT button is not required. Such a mechanism, however, requires an extra dialog box (in comparison with the form control, in order to verify that the just-recorded voice-gram should be transmitted). Thus, eliminating the SUBMIT button really does not reduce the number of user actions.

For links with “mailto:” scheme URLs, when the user attempts to follow such a link, the browser automatically changes to the Message mode, opens a new, blank message, and pre-loads the destination address with the address specified by the URL.

An ISVOICEGRAM link attribute is applied to links (A and LINK tags) to specify that when such a link is followed, the browser should record and transmit a voice-gram to the server as part of the new-page request. The voice-grain is recorded using the same sequence of dialog boxes that are used for links using voicegram:-scheme URLs. The page containing the link remains displayed while the voice-gram is recorded, and is cleared to display the new page when recording is complete and the voice-gram has been sent. The data representing the voice-gram is transmitted as multipart/form-data using the POST method (assuming the server communication is HTTP or HTTPS). Preferably, the ISVOICEGRAM attribute is applied only to links whose URL uses http: or https:, or some other protocol that permits data-upload as part of a data request. It is preferably not used with, for example, ftp: or file: URLs because these protocols do not permit upload, or with voicegram: URLs because that protocol does not return new page data. If ISVOICEGRAM is used with a mailto: URL, the client records a voice-gram, encodes it as a standard MIME e-mail attachment, and transmits it to the destination address without automatically changing to Message mode. In this case, as with all mailto: URLs, a new page is not loaded.

### Zoom Screen in Browse Mode

The Zoom screen in Browse mode is used to look at images embedded within web pages at multiple resolutions. Typically, when an image is displayed in the Browsing Screen, it is scaled to a relatively small size in order to preserve the over-all layout of the page. To view an image in the full size of the primary display area, or to scale the image so that it is larger than the size of the primary display area and viewed by scrolling, the Zoom Screen is used. While the Zoom Screen is displayed, the selected image continues to be handled in the same way it was while embedded in the page. For example, if the image is an animated GIF, its animation continues to operate. If the image is a link, then pressing the Select key while the input focus is in the primary display area will cause the browser to follow the link and automatically revert to the Browsing Screen. If the image is an “image map,” then the user may continue to use it for navigation and follow any of the links. If there is an audio data playback ongoing in the source page when the Zoom command is invoked, that playback continues while the user is viewing the Zoom Screen.

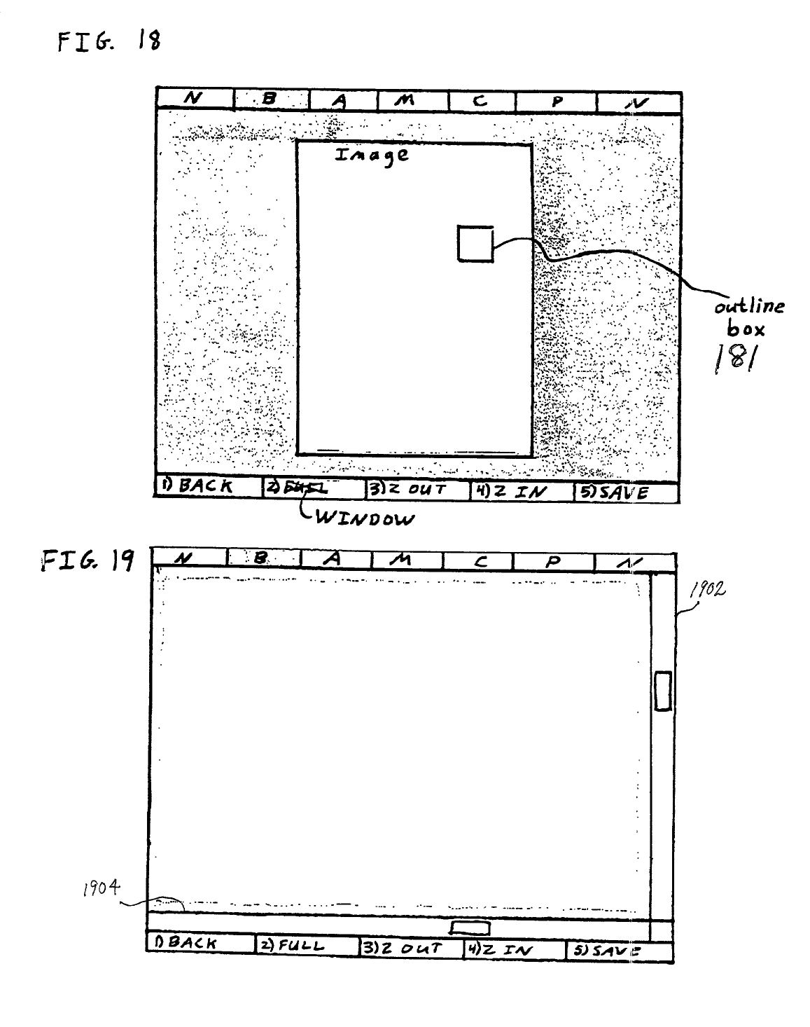

The primary display area in the Zoom screen has two alternative layouts, Windowed and Full-Screen, and the WINDOW/FULL command is used to toggle back and forth between them. In both displays, a single command button bar is present at the bottom of the screen. The Full-Screen configuration (FIG. 18), which is the default when the Zoom Screen is entered, shows the selected image scaled to fill the entire primary display area. As shown in FIG. 18, the browser draws a rectangle (the “outline box”) 181 within the image showing the portion of the image which will be displayed in the Windowed configuration if the Window command is invoked. This box may be erased if a predetermined time period such as 10 seconds elapse without a key being pressed. The box may be redrawn following any key press. When the input focus is on the primary display area, the direction keys move the outline box 181 within the image. The Windowed configuration (FIG. 19) shows a zoomed-in portion of the selected image. In this configuration, horizontal 1904 and vertical 1902 scroll bars are drawn along the bottom and right edges, respectively, of the primary display area. The primary display area is filled with the portion of the image visible in the outline box 181 in the Full-Screen configuration. In this configuration, when the input focus is on the primary display area, the direction keys scroll the image within the display, updating the scroll bars accordingly.

If the selected image to be zoomed is an Image Map, then the navigation hints, or the area outlines for client-side or grid for server-side, used in the Browsing Screen are also displayed in the Zoom Screen, regardless of configuration. Whatever selectable area is closest to the middle of the outline box is outlined in the select color and will be selected and the information sent to the server when the Select key is pressed.

The commands available in the Zoom screen display include: 1) BACK, 2) WINDOW/FULL, 3) Z OUT, 4) Z IN, and 5) SAVE. When the Back command is invoked, the browser redisplays the Browsing Screen in its prior state. The Window/Full command toggles between the Full-Screen configuration and the Windowed configuration. The Z Out command changes the scale factor applied to the image in the Windowed configuration display. In other words, it changes the size of the outline box relative to the size of the image. This command zooms “out”, so that the size of the outline box increases by a predetermined amount such as 50%. The Z In command zooms “in”, so that the size of the outline box decreases by a predetermined amount such as 33%. The Save command copies the current image or video item to the “incoming” data Album, in similar ways as the Save command in the Browsing Screen display.

### Help Mode

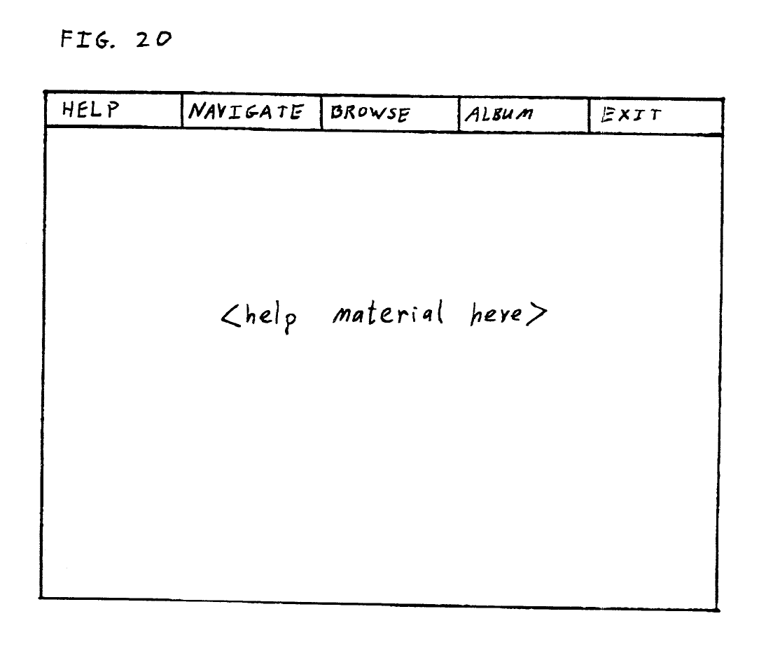

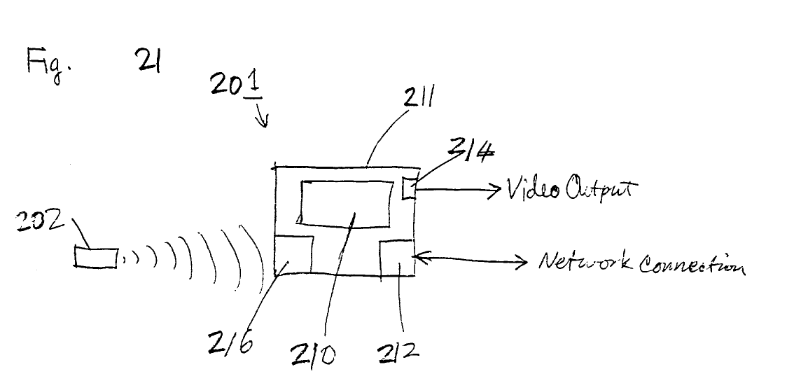

The browser implements Help mode as a special case of Browse mode. In Help mode, the primary and secondary command bars are not drawn; the scroll bars are not drawn; data can be displayed from either the local file system of the Internet appliance or from the network; and all pages are displayed as if the SELECT LINK command were most-recently invoked. Pages and data are specially prepared for Help mode, and are created so that they will fit the page space exactly (FIG. 20), and so that they explicitly manage the assignment of interface device keys and links. Help mode implements a context-sensitive help system. This is done by defining a mapping between the status of the application prior to the user selecting Help mode, and the URLs that are loaded into the initial display each time Help mode is entered. URLs are created by composing, from left to right, the elements listed below. The steps in the list that are marked “Help key:” are included only to supported a reduced-keyset user interface device with a separate, full-time Help key and are omitted for a reduced-keyset user interface device not having such a key.

file://browser-help/, which may be the name of the site providing the help material

Help key: If the mode button bar has the input focus, the string Mode/ is appended, followed by the name of the currently-selected mode button (i.e., Navigate/ or Browse/). In this case, no other strings are appended.

The name of the current mode (the one selected prior to Help mode), followed by a slash (i.e., Navigate/ or Browse/)

The name of the current sub-mode, followed by a slash (i.e., Browsing/ or Zoom/). If the current mode has only one (unnamed) sub-mode, the string is Default/.

Help key: If the command button bar has the input focus, the name of the currently-selected command button is appended (i.e., Back/ or Save/).

Help key: If the advertising area has the input focus, the string Ad/ is appended.

A keyword indicating the type of element currently selected in the central screen area, such as Url, Link/ or Image/.

The string index.html, indicating the primary page file for the created directory path.

If the page named by URL as computed above does not exist, then the browser attempts to find successively less-specific help (index.html) files by successively creating URLs with one less directory at a time on the right hand end. As an example, the search order for a particular system configuration could be:

1. file://browser-help/Browse/Browsing/Link/index.html

2. file://browser-help/Browse/Browsing/index.html

3. file://browser-help/Browse/index.html

4. file:/lbrowser-help/index.html

Given this structure, it may be required to have the same help information at multiple positions. Symbolic links may be used in these cases to prevent the actual data from having to be replicated. In addition, a BASE tag may be used in the actual page to force relative links into the directory containing the real files. This eliminates the need to have a symbolic link for any file other than index.html, further reducing the wasted file system storage.

If Help mode is displayed immediately following application initialization, the initial URL is stored as part of the system configuration information specifying the initialization state of the application. However, the expected URL in this case is file://browser-help/index.html. A help file of this name will always exist in systems containing a version of the browser application built to include the Help mode.

In addition, URLs that are present on the Recommended list in Navigate mode may also have an associated help path. If the system is in Browse mode and a page is being displayed from a Recommended site with a help path, then pages in Help mode can contain a link to the site-specific help information. This is accomplished by special script predicates that the browser makes available to each page in Help mode so that the page can format itself differently depending on whether or not there is a help destination page, and through a special symbolic link that the browser dynamically creates from the URL file://browser-help/site-help.html to the locally-stored root help page for the currently-displayed site.

The Navigation and Browse modes of the browser are described above in detail. Other modes are implemented in the browser in similar ways as the Navigation and Browse modes, including the Album, Chat, Multi-Application Support, Message, News, and Internet Telephone/Message modes, as well as the EXIT Function.

For example, in the Album mode, the browser handles whole HTML pages that the user saves. The Album mode supports display and manipulation of individual items, such as images and video files, audio clips, text blobs, as well as display of a composite item such as a web page. Low-resolution images representing a saved page may be created at the time it is saves, by capturing the display pixels in Browse mode and down-sampling. When the user wants to view it, the layout engine from Browse mode may be invoked to create a full-screen scrollable item that cannot be internally navigated. If the user wants to actually browse it, a command in Album mode may be provided that invokes browse mode with a dummy-URL that essentially points to the representation of the page on the storage server.

The browser may be implemented in software, and the graphic user interface features described above may be realized using a variety of programming methods known to those skilled in the art.

Although features of the web browser are described in detail, it will be apparent to those skilled in the art that various modifications and variations can be made in the browser without departing from the spirit or scope of the inventions. Thus, it is intended that the present invention cover modifications and variations of this invention that come within the scope of the appended claims and their equivalents.

1. A user interface method in a browser application implemented in an Internet appliance for accessing information on the Internet, the Internet appliance having a display device and using a reduced-keyset user interface device for user input, the reduced-keyset user interface device having a plurality of keys consisting of direction keys, numeric keys, and a number of function keys, the method comprising:
displaying a user interface screen on the display device, the screen being divided into a primary screen area for displaying information and at least a first and a second control area, the first control area containing one or more mode icons for selecting a mode of the browser application, the second control area containing one or more command icons depending on the selected mode;
in a navigate mode, displaying a plurality of interface elements in the primary screen area, each interface element representing a web page, and accessing one of the web pages by invoking a command icon or an interface element in response to user input through the use of the reduced-keyset user interface device;
in a browse mode, displaying page contents of a web page in the primary screen area, the web page including one or more interface elements, and further displaying different page contents by invoking a command icon or an interface element in response to user input through the use of the reduced-keyset user interface device; and
in the navigate and/or browse mode, dynamically displaying indications that associate each of one or more command icons and/or interface elements with a key of the reduced-keyset user interface device, and invoking a command icon and/or interface element in response to user input through the use of the associated key.
